(19) United States
(12) Patent Application Publication
(10) Pub. No.: US 2016/0176064 A1
(43) Pub. Date: Jun. 23, 2016

(54) CUTTING DEVICE

(71) Applicant: MAKITA CORPORATION, Anjo-shi (JP)

(72) Inventors: Katsumi OKOUCHI, Anjo-shi (JP); Kenji ABE, Anjo-shi (JP); Yuki WADA, Anjo-shi (JP); Yohei OGINO, Anjo-shi (JP); Anupong PHONHAN, Anjo-shi (JP); Atsushi KANOU, Anjo-shi (JP)

(73) Assignee: MAKITA CORPORATION, Anjo-shi (JP)

(21) Appl. No.: 15/057,790

(22) Filed: Mar. 1, 2016

Related U.S. Application Data
(63) Continuation of application No. 14/808,958, filed on Jul. 24, 2015.
Application No. 14/808,958 is a continuation of application No. PCT/JP2013/082943, filed on Dec. 9, 2013.
Application No. PCT/JP2013/082943 is a continuation of application No. PCT/JP2013/082836, filed on Dec. 6, 2013.

(30) Foreign Application Priority Data
Feb. 1, 2013 (JP) 2013-018862
Feb. 1, 2013 (JP) 2013-018863

(51) Int. Cl. B27B 9/02; B23D 59/00; B25F 5/02

(52) U.S. Cl. CPC B27B 9/02; B25F 5/02; B23D 59/006

(57) ABSTRACT

Two batteries (B1, B2) may be attached to a cutting tool (1), so that the total of the voltages of the two batteries connected in series with each other may be supplied to an electric motor (11) of the cutting tool. The electric motor may have a rated voltage that may be the same as the total of the voltages of the two batteries.

### CROSS REFERENCE TO RELATED APPLICATIONS

This application is a continuation application from PCT International Application No. PCT/JP2013/082836 claiming priority to Japanese Patent Application No. 2013-18863 filed Feb. 1, 2013, and from PCT International Application No. PCT/JP2013/082943 claiming priority to Japanese Patent Application No. 2013-18862 filed Feb. 1, 2013, the contents of which are incorporated herein by reference in their entirety for all purposes,

### BACKGROUND OF THE INVENTION

1. Field of the Invention

The present invention generally relate to a rechargeable cutting tool for cutting wood etc., and, in particular, to a hand-held type or portable cutting tool.

2. Related Art

Techniques related to a hand-held type cutting tool using a rechargeable battery as a power source may be disclosed in Japanese Laid-Open Patent Publication No. 2010-201598. This type of cutting tool, which may be called a portable circular saw, may be equipped with a base adapted to contact with the upper surface of a workpiece to be cut, and a cutting tool main body supported on the upper surface side of the base. The cutting tool main body may be equipped with an electric motor as a drive source, a rotary circular cutting blade, a main body case primarily covering the upper circumferential half of the cutting blade, an opening/closing type movable cover primarily covering the lower circumferential half of the cutting blade, and a handle portion to be grasped by the user. As the user grasping the handle portion moves the cutting tool in a cut proceeding direction, the cutting blade protruding on the lower surface side of the base may cut into the work, whereby the cutting operation is performed.

As batteries for electric tools including the cutting tools of this type, ones having an output voltage of, for example, 18 V or 36 V may be generally available. Mainly for the hand-held type tools having a relatively small size and having a small output, an 18 V output battery (18 V battery) may be used, and for cutting tools or the like having a relatively large size (and of high output) and requiring higher output, a 36 V output battery (36 V battery) may be used.

However, conventionally, because an 18 V battery may not be applied to a high-output cutting tool using a 36 V battery as a dedicated power source, there may be nothing for it for the user but to separately procure a 36 V battery dedicated for high-output cutting tools, resulting in a rather high cost; further, there has been room for improvement in terms of ease of handling of a high-output cutting tool.

There has been a need in the art for techniques of enhancing the convenience in use and usability of the cutting device.

### SUMMARY

In one aspect according to the present disclosure, a cutting tool may comprises a base adapted to contact with a workpiece to be cut, and a cutting tool main body supported on an upper surface side of the base. The cutting tool main body may include an electric motor as a drive source, a circular cutting blade rotated by the electric motor, and a handle portion to be grasped by a user. A cutting operation may be performed by causing a portion of the cutting blade extending on the lower surface side of the base to be cut into the workpiece. The cutting tool main body may be provided with a plurality of battery attachment portions that may be adapted for detachably attaching rechargeable batteries as a power source and for attaching the batteries in an exposed state visible from an outside.

In this way, it is possible to use a high-output cutting tool by attaching two low-output batteries thereto, whereby it is possible to effectively utilize low-output batteries, and to further enhance the convenience and ease of handling of a high-output cutting tool.

In accordance with an embodiment, the two battery attachment portions may be configured to be capable of attaching two batteries in a state of being positioned laterally side-by-side in a cut proceeding direction. With this embodiment, it is possible to attach the two batteries in a state of being positioned laterally side by side, with their longitudinal direction crossing the cut proceeding direction, and with their short side direction extending along the cut proceeding direction, and therefore, it is possible to attach the two batteries so as to be compact in the cut proceeding direction and, eventually, to make the cutting tool with the battery attached to be more compact with respect to the cut proceeding direction.

In accordance with an embodiment, the battery attachment portions may be configured to be capable of attaching the batteries of rectangular parallelepiped shapes with shortest sides thereof oriented in an up-down direction. With this embodiment, it is possible to attach the two batteries to be compact in the up-down direction, whereby it is possible to make the cutting tool with the battery attached to be compact with respect to the up-down direction.

In accordance with an embodiment, the batteries may be capable of being attached to a region on a lower side of the handle portion. With this embodiment, the two batteries may not constitute an obstruction when the user grasps the handle, making it possible to ensure an excellent grasping performance of the handle portion.

In accordance with an embodiment, the attachment direction for the battery attachment portions may be perpendicular to a surface of the cutting blade. With this embodiment, it is possible to attach the batteries from a lateral side of the cutting blade, and, conversely, it is possible to detach the batteries by moving them toward the lateral side of the cutting blade, and therefore, when the cutting tool is placed on the floor in such a state that the side of the blade case opposite to the motor is oriented downward, it is possible to easily attach and detach the batteries to and from the battery attachment portions.

In accordance with an embodiment, the attachment direction for the battery attachment portions may be set at an angle of at least 45 degrees with respect to the handle portion. With this embodiment, when the handle portion is grasped by one hand, and the batteries are grasped by the other hand, it is possible to easily attach and detach the batteries to and from the battery attachment portions.

In accordance with an embodiment, the cutting tool main body may have a cutting depth adjustment mechanism that may be supported so as to be capable of changing a position in an up-down direction with respect to the base to vary an amount by which the cutting blade protrudes on a lower surface side of the base to thereby adjust a cutting depth into the workpiece. The cutting depth adjustment mechanism may be arranged between the cutting blade and the handle portion. With this embodiment, it is possible to resolve the difficulty in arranging the depth guide in an optimum fashion, which may be caused due to an increase in the size of the lower portion of the handle portion as a result of arranging the plurality of batteries.

In another aspect according to the present disclosure, a hand-held type electric cutting device may have a circular cutter tool that may be rotated by a motor powered by a battery operating as a power source. The electric cutting device may have a base dividing the circular cutter tool that is vertically arranged, into an upper region and a lower region. Further, the base may be pressed from above a workpiece to cut the workpiece by the circular cutting tool. Moreover, the base may accommodate a cutting depth by which the workpiece is cut by the circular cutter tool. A motor housing may be arranged to cover the motor. An upper blade case may be arranged to cover the upper region of the circular cutter tool. A handle may be arranged integrally with at least one of the motor housing and the blade case. The handle may be grasped during transportation and use of the hand-held type electric cutting device. Battery attachment portions may be directly or indirectly arranged at the motor housing or the blade case, so that a plurality of batteries, functioning as a power source, may be connected in series by attaching the plurality of batteries to the battery attachment portions.

In accordance with an embodiment, the motor may be arranged such that a rotation center line thereof may be parallel to a rotation center line of the circular cutter tool. The handle may be arranged at an upper portion of the motor so as to extend backwards with respect to a cut proceeding direction of the circular cutter tool, with a longitudinal direction of the handle crossing the rotation center line of the motor. A dust box may be provided as the upper blade case and may receive chips of the workpiece produced by the circular cutter tool. The battery attachment portions may be arranged such that the plurality of batteries are respectively attached to a front portion and a rear portion of the motor housing with respect to the cut proceeding direction of the circular cutter tool, with the front battery being attached on a side of the front portion of the handle, and the rear battery being attached on a side of a lateral portion of the handle so as to be spaced away from the handle.

In accordance with an embodiment, the motor may be arranged such that a rotation center line thereof may be parallel to a rotation center line of the circular cutter tool. The handle may be arranged at an upper portion of the motor so as to extend backwards with respect to a cut proceeding direction of the circular cutter tool, with a longitudinal direction of the handle crossing the rotation center line of the motor. A dust box may be provided as the upper blade case and may receive chips of the workpiece produced by the circular cutter tool. The battery attachment portions may be arranged such that the plurality of batteries may be respectively attached to a front portion between the handle and the dust box with respect to the cut proceeding direction of the circular cutter tool.

In accordance with an embodiment, the motor may be arranged such that a rotation center line thereof is parallel to a rotation center line of the circular cutter tool. The handle may be arranged at an upper portion of the motor so as to extend backwards with respect to a cut proceeding direction of the circular cutter tool, with a longitudinal direction of the handle crossing the rotation center line of the motor. The battery attachment portions may be arranged such that the plurality of batteries may be attached to a front portion of the handle and to a front portion of the motor housing.

In accordance with an embodiment, the motor may be arranged such that a rotation center line thereof may be parallel to a rotation center line of the circular cutter tool. The handle may be arranged at an upper portion of the motor so as to extend backwards with respect to a cut proceeding direction of the circular cutter tool, with a longitudinal direction of the handle crossing the rotation center line of the motor. The battery attachment portions may be arranged such that the plurality of batteries are respectively attached to a front portion and a rear portion of the motor housing with respect to the cut proceeding direction of the circular cutter tool, with the front battery being attached on a side of the front portion of the handle, and the rear battery being attached on a side of a lateral portion of the handle so as to be spaced away from the handle.

In accordance with an embodiment, the motor may be arranged such that a rotation center line thereof may cross to a rotation center line of the circular cutter tool. The handle may comprise a rear handle arranged at a rear portion of the motor with respect to a cut proceeding direction of the circular cutter tool, and a front handle arranged at a front portion of the motor. The battery attachment portions may be arranged such that the plurality of batteries may be attached to an upper portion of the motor housing and to an upper portion of the rear handle.

In accordance with an embodiment, the motor may be arranged such that a rotation center line thereof may cross to a rotation center line of the circular cutter tool. The handle may comprise a rear handle arranged at a rear portion of the motor with respect to a cut proceeding direction of the circular cutter tool, and a front handle arranged at a front portion of the motor. The battery attachment portions may be arranged such that the plurality of batteries may be attached to a lateral portion of the motor housing on a side spaced away from the upper blade case.

In accordance with an embodiment, the motor may be arranged such that a rotation center line thereof may be parallel to a rotation center line of the circular cutter tool. The handle may comprise a rear handle arranged at a rear portion of the motor with respect to a cut proceeding direction of the circular cutter tool, and a front handle arranged at a front portion of the motor. The rear handle may be arranged so as to extend backwards of the motor, with a longitudinal direction of the rear handle crossing the rotation center line of the motor. The front handle may be arranged so as to extend to a side opposite to the circular cutting tool with respect to the rear handle, with a longitudinal direction of the front handle being parallel to the rotation center line of the motor. The battery attachment portions may be arranged such that the plurality of batteries are respectively attached to a front portion and a rear portion of the motor housing, with the rear battery being attached on a side opposite to the circular cutting tool with respect to the rear handle so as to be spaced away from the rear handle, and the front battery being attached on a rear side of the front handle so as to be spaced away from the front handle.

In accordance with an embodiment, the motor may be arranged such that a rotation center line thereof may be parallel to a rotation center line of the circular cutter tool. The handle may comprise a rear handle arranged at a rear portion of the motor with respect to a cut proceeding direction of the circular cutter tool, and a front handle arranged at a front portion of the motor. The rear handle may be arranged so as to extend backwards of the motor, with a longitudinal direction of the rear handle crossing the rotation center line of the motor. The front handle may be arranged so as to extend to a side opposite to the circular cutting tool with respect to the rear handle, with a longitudinal direction of the front handle being parallel to the rotation center line of the motor. The battery attachment portions may be arranged such that the plurality of batteries may be attached to an upper portion of the motor housing on a side opposite to the circular cutting tool with respect to the rear handle and on the rear side of the front handle so as to be spaced away from the rear handle and the front handle.

In accordance with an embodiment, the motor may be arranged such that a rotation center line thereof may be parallel to a rotation center line of the circular cutter tool. The handle may be arranged at an upper portion of the motor so as to extend backwards with respect to a cut proceeding direction of the circular cutter tool, with a longitudinal direction of the handle crossing the rotation center line of the motor. The battery attachment portions may be arranged such that the plurality of batteries may be attached to an upper portion of the motor housing on a front side of the handle with respect to a cut proceeding direction of the circular cutter tool.

In accordance with an embodiment, the motor may be arranged such that a rotation center line thereof may be parallel to a rotation center line of the circular cutter tool. A dust box may be provided as the upper blade case and may receive chips of the workpiece produced by the circular cutter tool. The handle may comprise a rear handle arranged at a rear portion of the dust box with respect to a cut proceeding direction of the circular cutter tool, and a front handle arranged at a front portion of the dust box. The rear handle may be arranged so as to extend backwards of the motor, with a longitudinal direction of the rear handle crossing the rotation center line of the motor. The front handle may be arranged so as to extend to a side of the motor with respect to the rear handle, with a longitudinal direction of the front handle being parallel to the rotation center line of the motor. The battery attachment portions may be arranged such that the plurality of batteries may be attached to the front handle at positions on a front side of the motor housing with respect to the cut proceeding direction and spaced away from a grip portion of the front handle.

In accordance with an embodiment, the motor may be arranged such that a rotation center line thereof may be parallel to a rotation center line of the circular cutter tool, A dust box may be provided as the upper blade case and may receive chips of the workpiece produced by the circular cutter tool. The handle may comprise a rear handle arranged at a rear portion of the dust box with respect to a cut proceeding direction of the circular cutter tool, and a front handle arranged at a front portion of the dust box. The rear handle may be arranged so as to extend backwards of the motor, with a longitudinal direction of the rear handle crossing the rotation center line of the motor. The front handle may be arranged so as to extend to a side of the motor with respect to the rear handle, with a longitudinal direction of the front handle being parallel to the rotation center line of the motor. The battery attachment portions may be arranged such that the plurality of batteries may be attached to a front portion of the motor housing at positions on a rear side of the front handle with respect to the cut proceeding direction and spaced away from a grip portion of the front handle.

### BRIEF DESCRIPTION OF THE DRAWINGS

FIG. 1 is an overall front view of a cutting tool according to a first embodiment.

FIG. 2 is a plan view, as seen from a direction of arrow (II) in FIG. 1, of the cutting tool of the first embodiment.

FIG. 3 is a rear view, as seen from a direction of arrow (III) in FIG. 2, of the cutting tool of the first embodiment.

FIG. 4 is a bottom view, as seen from a direction of arrow (IV) in FIG. 3, of the cutting tool of the first embodiment. This figure shows the state in which the two batteries have been removed. In this figure, the base is omitted.

FIG. 5 is a vertical sectional view, taken along arrow line (V)-(V) in FIG. 1, of the cutting tool according to the first embodiment.

FIG. 6 is a perspective view of a battery only.

FIG. 7 is a side view of a second embodiment.

FIG. 8 is a front view of the second embodiment.

FIG. 9 is a plan view of the second embodiment.

FIG. 10 is a side view of a third embodiment.

FIG. 11 is a front view of the third embodiment.

FIG. 12 is a plan view of the third embodiment.

FIG. 13 is a side view of a fourth embodiment.

FIG. 14 is a front view of the fourth embodiment.

FIG. 15 is a plan view of the fourth embodiment.

FIG. 16 is a side view of a fifth embodiment.

FIG. 17 is a front view of the fifth embodiment.

FIG. 18 is a plan view of the fifth embodiment.

FIG. 19 is a side view of a sixth embodiment.

FIG. 20 is a front view of the sixth embodiment.

FIG. 21 is a plan view of the sixth embodiment.

FIG. 22 is a side view of a seventh embodiment.

FIG. 23 is a front view of the seventh embodiment.

FIG. 24 is a plan view of the seventh embodiment.

FIG. 25 is a side view of an eighth embodiment.

FIG. 26 is a front view of the eighth embodiment.

FIG. 27 is a plan view of the eighth embodiment.

FIG. 28 is a side view of a ninth embodiment.

FIG. 29 is a front view of the ninth embodiment.

FIG. 30 is a plan view of the ninth embodiment.

FIG. 31 is a side view of a tenth embodiment.

FIG. 32 is a front view of the tenth embodiment.

FIG. 33 is a plan view of the tenth embodiment.

FIG. 34 is a side view of an eleventh embodiment.

FIG. 35 is a front view of the eleventh embodiment.

FIG. 36 is a plan view of the eleventh embodiment.

FIG. 37 is a side view of a twelfth embodiment.

FIG. 38 is a front view of the twelfth embodiment.

FIG. 39 is a plan view of the twelfth embodiment.

FIG. 40 is a side view of a thirteenth embodiment.

FIG. 41 is a front view of the thirteenth embodiment.

FIG. 42 is a plan view of the thirteenth embodiment.

FIG. 43 is a front view illustrating a battery attachment portion of the second embodiment along with a battery.

FIG. 44 is a side view of an example of the ninth embodiment.

FIG. 45 is a front view of an example of the ninth embodiment.

FIG. 46 is a plan view of the example of the ninth embodiment.

### DETAILED DESCRIPTION OF EMBODIMENTS

### First Embodiment

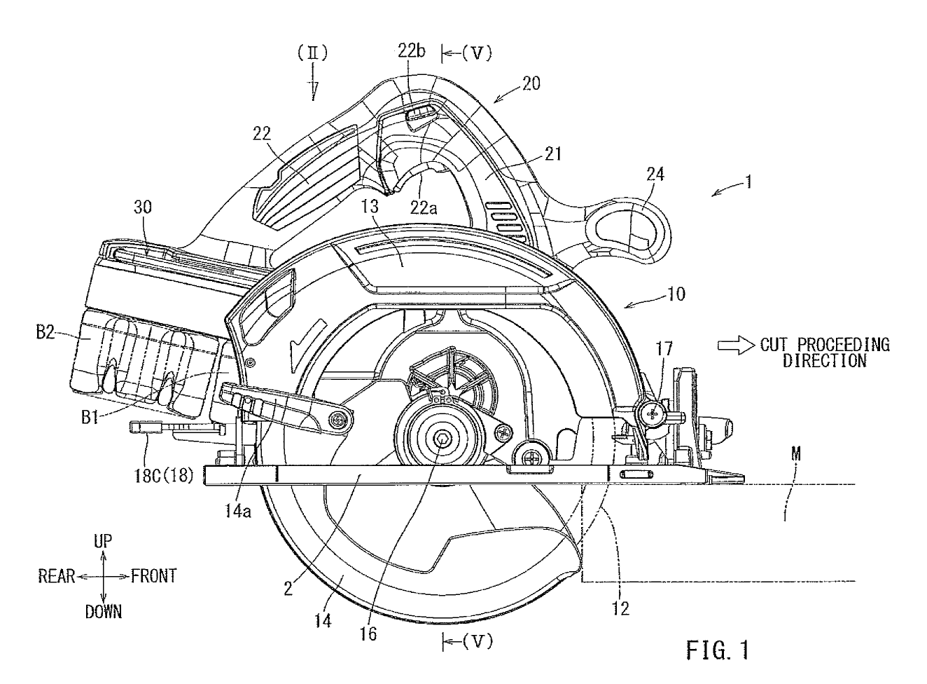

In the following, a first embodiment will be described with reference to FIGS. 1 through 6. FIG. 1 shows a rechargeable cutting tool 1 according to the embodiment. This cutting tool 1 may be a hand-held type cutting tool also called as a portable circular saw. The cutting tool 1 may include a base 2 formed substantially as a rectangular flat plate and adapted to contact with the upper surface of a workpiece M to be cut. The cutting tool 1 may further include a cutting tool main body 10 supported on the upper surface side of the base 2.

The cutting tool main body 10 may include an electric motor 11 configured to function as a drive source. The cutting tool main body 10 may further include a circular cutting blade 12 rotated by the electric motor 11. The range of the upper circumferential half of the cutting blade 12 may be covered with a blade case 13, The range of the lower circumferential half of the cutting blade 12 may be covered with a movable cover 14. The movable cover 14 may open and close along the circumference of the cutting blade 12. As the cutting operation proceeds, the movable cover 14 may contact an end surface of the workpiece M, and may rotate clockwise as seen in FIG. 1 to open. Further, the movable cover 14 may be opened and closed by a manual operation through grasping a releasing lever 14a disposed at the upper end portion of the movable cover 14.

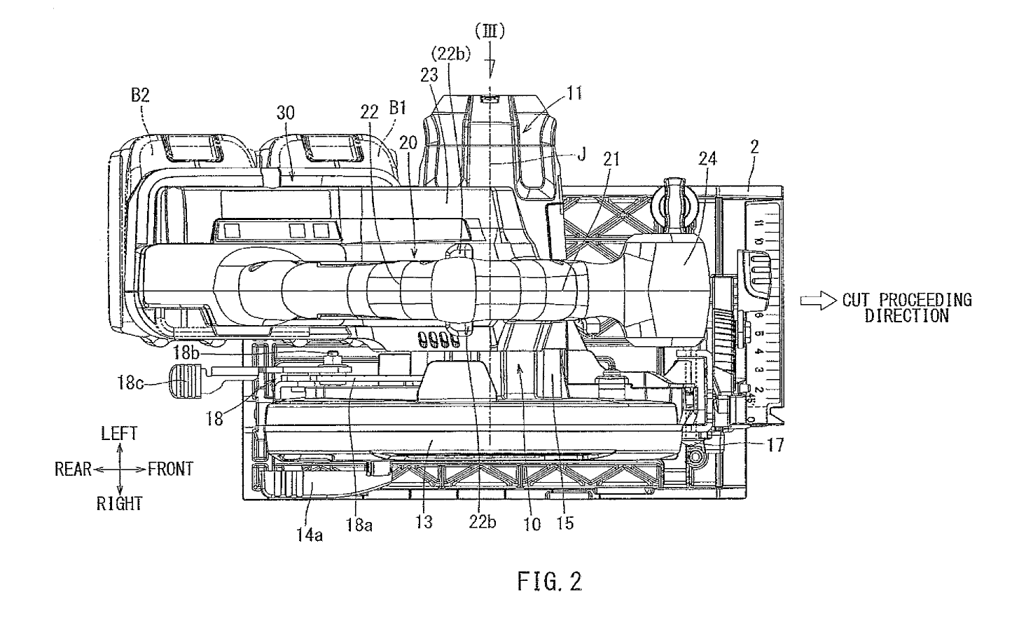

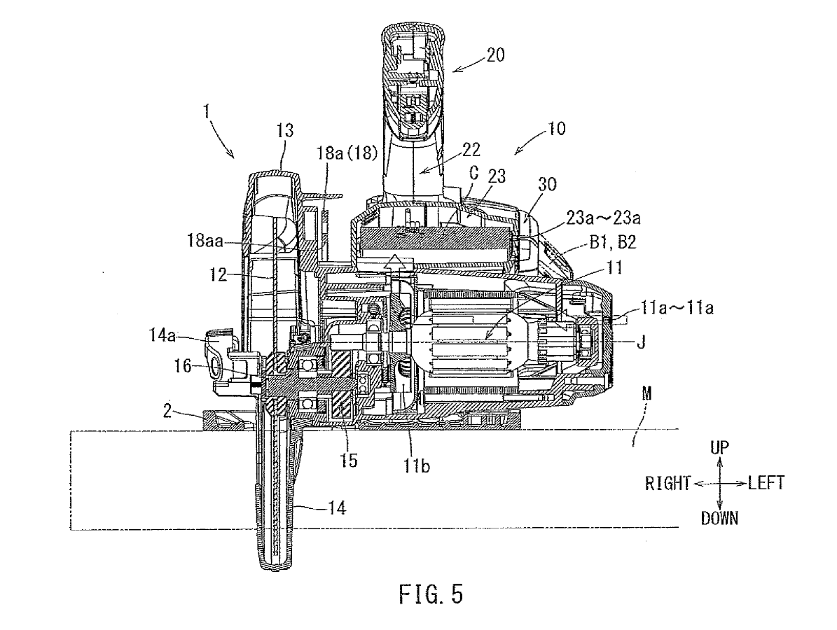

As shown in FIGS. 2 and 5, the electric motor 11 may be mounted to the left side surface (backside surface) of the blade case 13 via a speed reduction gear portion 15. The motor axis J of the electric motor 11 may extend orthogonal to the cut proceeding direction. The output shaft (i.e., a spindle 16) of the speed reduction gear portion 15 may extend into the blade case 13 such that the cutting blade 12 may be mounted to this extending portion of the output shaft.

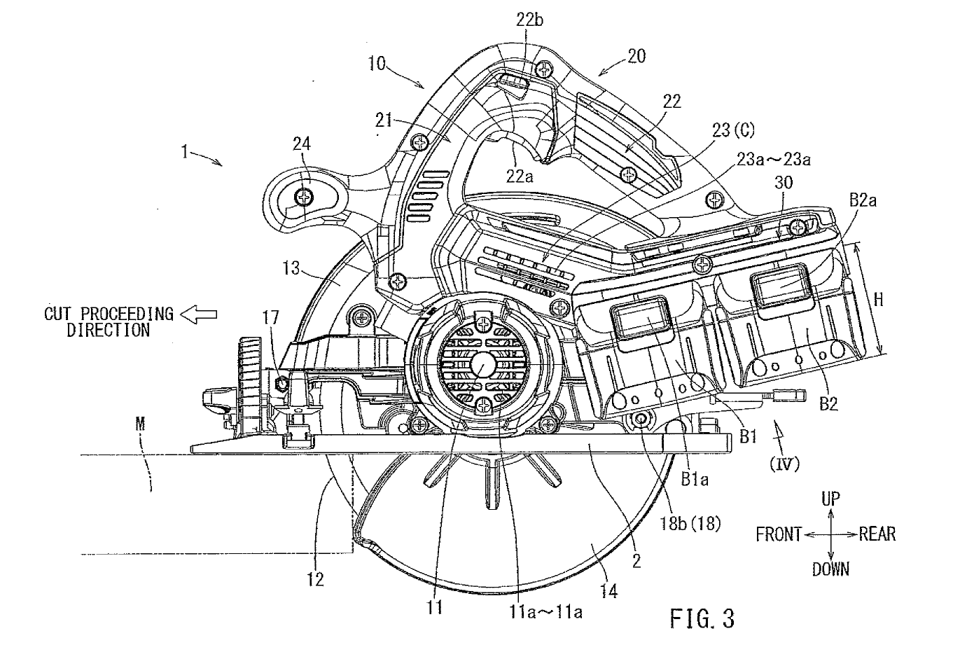

At the upper portion of the electric motor 11, there may be provided a loop-shaped handle portion 20 adapted to be grasped by the user. The user may grasp the handle portion 20 while positioned on the left side of the cutting tool 1 in FIG. 1 (on the right side in FIG. 3), and on the rear side with respect to the cut proceeding direction.

As shown in FIG. 3, the handle portion 20 may be substantially of an angle shape. The handle portion 20 may include a vertical portion 21 on the front side, a grasping portion 22 inclined backwards and downwards from the upper portion of the vertical portion 21, and a base portion 23 connecting the lower portion of the vertical portion 21 to the rear portion of the grasping portion 22, The vertical portion 21 may include a front grip portion 24 protruding forwards from the vertical portion 21. A trigger-type switch lever 22a may be disposed at the lower surface of the front end of the grasping portion 22. When this switch lever 22a may be upwardly pulled with a fingertip of a hand grasping the grasping portion 22, the electric motor 11 may activate to rotate the cutting blade 12. On the upper side of the switch lever 22a, there may be provided a lock-off lever 22b for locking the switch lever 22a in a non-operating state. The right and left end portions of this lock-off lever 22b may protrude from the right and left sides of the grasping portion 22, and may be operated from both the right and left sides, Downwardly depressing the lock off lever 22b may release the locked state to allow the switch lever 22a to be pulled. Due to this lock-off function, it is possible to prevent an accidental erroneous operation.

The cutting tool main body 10 may be vertically tiltably supported by the base 2 via a vertical tilt support shaft 17. Changing the vertical tilting position of the cutting tool main body 10 with respect to the base 2 may alter the amount by which the cutting blade 12 extends on the lower surface side of the base 2, whereby it is possible to adjust the cutting depth of the cutting blade 12 into the workpiece M.

As shown in FIG. 2, in the space between the handle portion 20 and the blade case 13, which is the space on the rear side of the speed reduction gear portion 15, there may be provided a cutting depth adjustment mechanism 18 for adjusting the cutting depth of the cutting blade 12 into the workpiece M. The cutting depth adjustment mechanism 18 may include a depth guide 18a disposed at the upper surface of the base 102 so as to extend upwards in an elongated manner. The cutting depth adjusting mechanism 18 may further include a fixation screw 18b for fixing the blade case 13 to the depth guide 18a. As indicated by reference numeral 18aa in FIG. 5, the depth guide 18a may have a guide slot hole 18aa extending along an arc about the above-mentioned vertical tilt support shaft 17. The fixation screw 18b may be inserted into the guide groove hole 18aa. The fixation screw 18b may be screwed into the rear surface of the blade case 13. A fixation lever 18c for rotational operation may be mounted to the fixation screw 18b. By grasping the fixation lever 18c and turning the fixation screw 18b by a given angle, the fixation screw 18b may be tightened or loosened with respect to the rear surface of the blade case 13. By tightening the fixation screw 18b, the vertical tilting position of the cutting tool main body 10 with respect to the base 2 may be fixed, so that an amount by which the cutting blade 12 extends on the lower surface side of the base 2 (i.e., the cutting depth into the workpiece M) may be fixed. In the configuration shown in FIGS. 1 and 3, the cutting tool main body 10 may be fixed at the lowermost tilting position with respect to the base 2, and the cutting depth of the cutting blade 12 may be adjusted to be maximum. By moving the cutting tool main body 10 to a tilting position that is higher with respect to the base 2 as compared with the configuration shown in FIGS. 1 and 3, the cutting depth of the cutting blade 12 may be reduced.

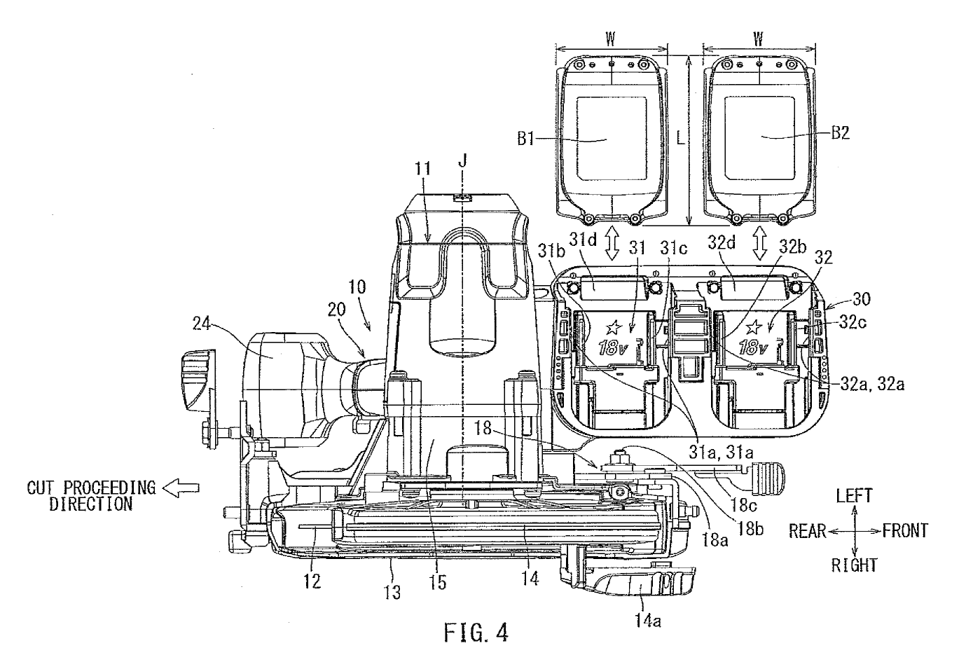

At the rear portion of the handle portion 20 (the user side), which is the rear portion of the grasping portion 22 and also the rear portion of the base portion 23, there may be provided a battery attachment base portion 30. As shown in FIG. 4, this battery attachment base portion 30 may be arranged so as to extend toward the rear side of the electric motor 11. As shown in FIG. 3, the battery attachment base portion 30 may be generally shaped as a flat plate and may be inclined upward in the backward direction from the rear portion of the base portion 23 of the handle portion 20. Due to the battery attachment base portion 30 thus arranged so as to be inclined obliquely upward in the backward direction, in the configuration in which the cutting depth of the cutting blade 12 is maximum as shown in FIG. 3, the rear battery B2 may be attached at a position upwardly displaced as compared with the front battery B1. As a result, even in a configuration in which the cutting tool main body 10 is tilted upwards with respect to the base 2 about the vertical tilting support shaft 17 to thereby decrease the cutting depth, the rear battery B2 may not interfere with the base 2. Eventually, the cutting depth adjustment mechanism 18 of the cutting tool 1 may properly function.

As shown in FIG. 4, two battery attachment portions 31, 32 may be disposed at the lower surface of the battery attachment base portion 30. Slide attachment type batteries B1, B2 may respectively be attached to the two battery attachment portions 31, 32.

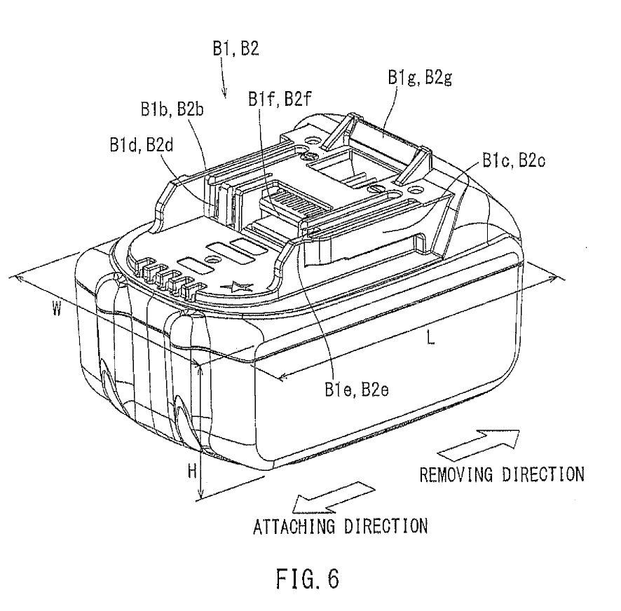

As shown in FIG. 6, each of the two batteries B1, B2 may be an 18 V output lithium ion battery accommodating a plurality of battery cells in a battery case. Each of the two batteries B1, B2 may be repeatedly used as a power source by being detached from the cutting tool 1 and recharged by a charger that may be separate of the cutting tool 1, Each of two batteries B1, B2 may include a pair of right and left rail portions B1b, B1c, B2b, B2c at the upper surface thereof. Between the right and left rail portions B1b and B1c, and B2b and B2c, there may be provided positive and negative connection terminals B1d, B1e, B2d, B2e, Between the positive and negative connection terminals B1d and B1e, and between the positive and negative connection terminals B2d and B2e, there may be provided connectors B1f, B2f for transmitting and receiving a control signal between the batteries and the charger.

At the end portion on the front side of the upper surface of the battery B1, B2 with respect to the detachment direction, there may be provided a lock claw B1g, B2g capable of advancing and retracting in the up-down direction for locking the battery B1, B2 in the attached state with respect to the battery attachment portion 31, 32.

In this embodiment, the two 18 V batteries B1, B2 may be connected in series to serve as a 36 V battery. Thus, the electric motor 11 may be powered by a 36 V power output from the two 18 V batteries B1, B2 connected in series.

As shown in FIG. 4, each of the two battery attachment portions 31, 32 may include a pair of rail portions 31a, 31a, 32a, 32a arranged in the front-rear direction, and may also include positive and negative connection terminals 31b, 31c, 32b, 32c. The battery B1, B2 may be mechanically detachably attached, by engaging the rail portions 31a, 31a, 32a, 32a arranged in pair in the front-rear direction, with the rail portions B1b, B1c, B2b, B2c of the battery B1, B2, and by sliding the battery B1, B2 along the rail portions 31a, 31a, 32a, 32a. Further, the battery B1, B2 may be electrically connected by connecting the positive and negative connection terminals B1d, B1e, B2d, B2e of the battery B1, B2 to the positive and negative connection terminals 31b, 31c, 32b, 32c.

Further, at the left side end portion of each of the two battery attachment portions 31 and 32, there may be provided a claw engagement portion 31d, 32d configured to engage the lock claw portion B1g, B2g provided on the battery B1, B2 for locking the attached state.

As indicated by outline arrows in FIGS. 4 and 6, moving the battery B1, B2 downward in FIG. 4 (attachment direction) relative to the battery attachment portion 31, 32 may attach the battery B1, B2 to the battery attachment portion 31, 32. Conversely, moving the battery B1, B2 upward in FIG. 4 (detachment direction) relative to the battery attachment portion 31, 32 may detach the battery B1, B2 from the battery attachment portion 31, 32.

As shown in FIG. 3, at the front surface in the detachment direction of the battery B1, B2, there may be provided a lock release button B1a, B2a for releasing the engagement of the lock claw B1g, B2g with the claw engagement portion 31d, 32d of the battery attachment portion 31, 32.

As shown in FIG. 6, the battery B1, B2 may have a length L in the longitudinal direction, a width W, and a height H. The battery B1, B2 may be generally of a rectangular parallelepiped shape with the length, width and height demonstrating a relationship of “L>W>H”. The batteries B1, B2 may be attached to the battery attachment base portion 30 in such a manner that the batteries B1, B2 may be arranged laterally side-by-side on the front side and the rear side in the cut proceeding direction, with their longitudinal directions extending along the right-left direction. Further, as shown in FIG. 3, the battery B1, B2 may be attached to the battery attachment base portion 30 where the height, i.e., its shortest side (height H) of each of the batteries B1, B2 may be oriented in the up-down direction.

The direction in which each of the two batteries B1, B2 is attached and detached to and from the battery attachment portion 31, 32 may be perpendicular to the surface direction of the cutting blade 12, so that the attaching and detaching directions may be parallel to the motor axis 3 and the axial direction of the spindle 16.

The electric power of the batteries B1, B2 attached to the battery attachment portions 31, 32 may be supplied to the electric motor 11 via a controller C that may include a power source circuit. As shown in FIG. 5, the controller C may be accommodated in the base portion 23 of the handle portion 20. The interior of the base portion 23 may be in communication with the interior of the electric motor 11. Therefore, as indicated by an outline arrow in FIG. 5, the motor cooling air, which may be drawn via air inlet openings 11a (See FIG. 3) provided in the rear surface of the motor by the rotation of a cooling fan 11b of the electric motor 11, may be directly introduced to the base portion 23, and utilized as the cooling air for cooling the controller C. As shown in FIG. 3, at the left side portion of the base portion 23 as seen from the user, there may be provided air discharge openings 23a, The motor cooling air introduced into the base portion 23 may be discharged to the exterior via the air discharge openings 23a.

The rechargeable cutting tool 1 of this embodiment may be configured as a high-output cutting tool that may have the electric motor 11 powered by a rated voltage of 36 V by attaching two low-output 18 V batteries B1, B2. Therefore, it is possible to effectively utilize the low-output 18 batteries B1, B2, and to enhance the convenience and ease of handling of the cutting tool 1. In particular, widely available batteries inclusive those used as spare batteries, etc, may be used. For example, 16V batteries may be used for a high-output cutting tool with a 36 V specification without need of separately purchasing a potentially expensive 36 V battery. Therefore, it is possible to achieve remarkable operations and effects in terms of a reduction in the cost of cutting operation and an improvement of the operability.

Further, the two batteries B1, B2 may be attached to the two battery attachment portions 31, 32 in a laterally side-by-side configuration, with their longitudinal directions (the length L directions) crossing the cut proceeding direction, and with short-side directions (the width W directions) extending along the cut proceeding direction. As a result, the two batteries B1, B2 may be attached so as to be compact in the cut proceeding direction, so that the cutting tool 1 having the batteries attached thereto may be compact in the cut proceeding direction. Further, the two batteries B1, B2 may be attached with their directions of the height H, i.e., the shortest side oriented in the up-down directions, so that the two batteries B1, B2 may be attached compact in the up-down direction. Therefore, the cutting tool 1 having batteries attached thereto may be compact in the up-down direction.

Further, the batteries B1, B2 may be attached in a region on the lower side of the handle portion 20, so that the two batteries B1, B2 may not obstruct the user to access the handle portion 20 when the user grasps the handle portion 20, Therefore, an excellent grasping performance of the handle portion 20 and an excellent handling performance of the cutting tool 1 may be ensured. Further, when the user grasps the grip portion 22, the electric motor 11 and the batteries B1 and B2, which are relatively heavy components, may be respectively positioned on the front side and the rear side of the grasping hand, so that the cutting tool may be well-balanced when grasped. Accordingly, the grasping performance of the handle portion 20 and, eventually, the usability, operability, and ease of handling of the cutting tool 1 may be enhanced.

Further, the attachment and/or detachment direction of each of the two batteries B1, B2 with respect to the battery attachment portion 31, 32 may be perpendicular to the surface direction of the cutting blade 12, and thus be parallel to the motor axis J and the axial direction of the spindle 16. Therefore, the batteries B1, B2 may be attached to the battery attachment portions 31, 32 by moving the batteries B1, B2 from the lateral side of the cutting blade 12, Likewise, the batteries B1, B2 may be detached by moving the batteries B1, B2 toward the lateral side of the cutting blade 12. Accordingly, the batteries B1, B2 may be attached and detached quickly and easily with respect to the battery attachment portions 31, 32.

Further, in the this embodiment, the cutting tool main body 10 may be supported so as to be capable of changing a position in the up-down direction with respect to the base 2. Further, the cutting depth adjustment mechanism 18 may enable adjustment of the cutting depth of the cutting blade 12 into the workpiece M by changing the extending amount of the cutting blade 12 on the lower surface side of the base 2. The depth guide 18a and the fixation lever 18c may together constitute the cutting depth adjustment mechanism 18 and may be arranged between the blade case 13 covering the cutting blade 12 and the handle portion 20. Thus, as compared with the arrangement where such an adjustment mechanism (mainly the depth guide) is arranged inside the blade case, a failure in operation may be prevented as caused by adhesion of cutting chips or the like. Further, the above arrangement may effectively use a free space, which may help to enhance the durability and ease of maintaining the cutting tool 1.

The above embodiment may be modified in various ways. For example, in the above embodiment, the attachment and/or detachment direction of each of the batteries B1, B2 may be perpendicular to the surface of the cutting blade 12. However, the batteries may be attached as they are moved in directions that are inclined with respect to the surface of the cutting blade 12 and are oriented downwards in the attachment directions. In this construction, the batteries B1, B2 may be attached to the battery attachment portions by moving the batteries B1, B2 to slide obliquely downwards. Likewise, the batteries B1, B2 may be detached from the battery attachment portions by moving the batteries B1, B2 to slide obliquely upwards. Accordingly, the attachment and detachment of the batteries to and from the battery attachment portions may be quickly and easily performed.

Taking into consideration of ease of handling at the time of attachment and detachment of the batteries B1, B2, each of the batteries may be attached and detached along a direction inclined by an angle within 45 degrees relative to a direction perpendicular to the surface of the cutting blade 12, in place of attachment and detachment perpendicular to the surface of the blade 12 as in the above embodiment.

Further, in the above embodiment, the two batteries B1, B2 may be attached laterally side-by-side on the front side and the rear side in the cut proceeding direction. However, the two batteries B1, B2 may be attached longitudinally side-by-side, with their longitudinal directions extending along the cut proceeding direction, Regarding the attachment positions, while in the above embodiment, the batteries B1, B2 may be attached to the rear portion of the handle portion 20, the batteries B1, B2 may be attached to the front portion of the handle portion 20, the right and left side portions thereof, etc.

Further, while in the above embodiment, two batteries B1, B2 of 18 V specification may be attached to provide power to the cutting tool 1 of an output of 36 V, batteries of some other output voltage, e.g., 14.4 V specification may be used as a power source for an electric motor with a rated voltage that is the same as the total voltage of the batteries. In short, widely available batteries may be used as a power source for an electric motor with a rated voltage that is the same as the total voltage of the batteries. The cutting tool may use, a plurality of batteries possessed by the user as spare batteries or the like for the high-output cutting tool 1, whereby it is possible to propagate high-output cutting tools while avoiding an increase in battery cost.

### Second Embodiment

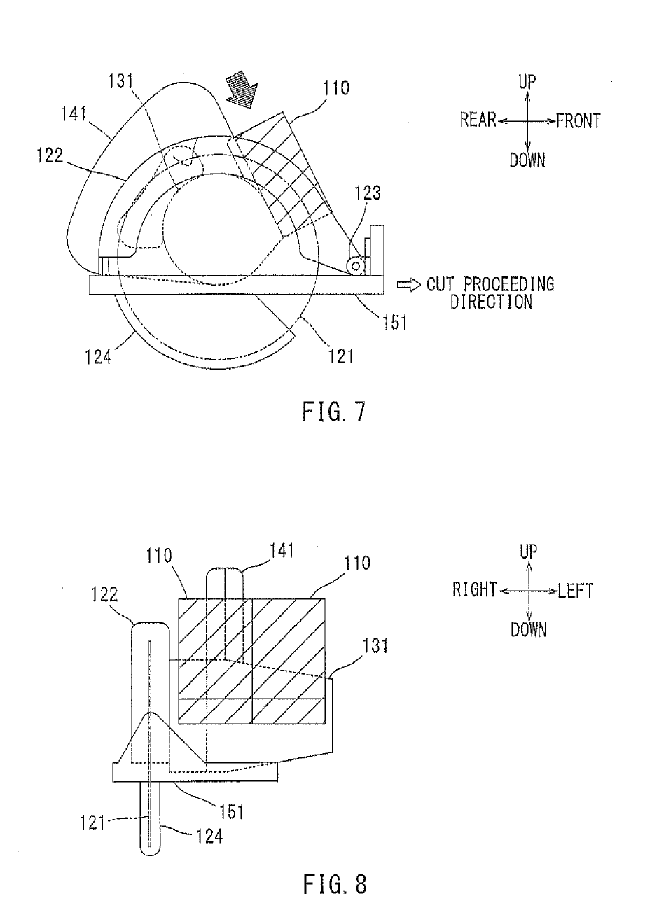

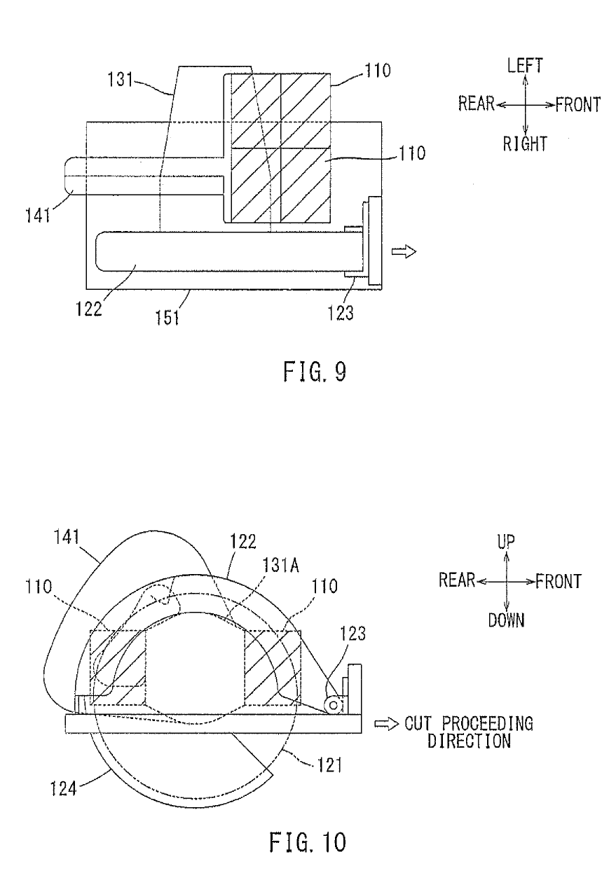

The second embodiment will be described with reference to FIGS. 7 through 9, The second embodiment relates to a woodworking circular saw. The woodworking circular saw may be of a rated voltage of 36 V, and may use, as a power source, two 18 V batteries 110 connected in series. This second embodiment may be substantially the same as a conventionally well-known woodworking circular saw, with the exception that the two batteries 110 may be used and connected in series, so a detailed description of a traditional woodworking circular saw will be omitted. In FIGS. 7 and 9, a direction indicated by an outline arrow with a labeling of “cut proceeding direction” may be the direction in which the woodworking circular saw moves while being pushed when the woodworking circular saw is used for cutting, that is, it indicates the wood cutting direction. Further, in FIGS. 7 through 9, the directions indicated by the crossing arrows may indicate the directions as labeled therein, with reference to the woodworking circular saw. Here, the forward direction may be the wood cutting direction, and the backward direction may be the opposite direction. The upward, downward, rightward, and leftward directions may correspond to the upper, lower, right, and left sides with reference to the woodworking circular saw when wood is cut while the woodworking circular saw is pushed in the wood cutting direction. Further, in FIGS. 7 through 9, the batteries 110 are shaded. The above description of the drawings may be also applied to the corresponding drawings of the subsequent embodiments.

The woodworking circular saw may be configured such that a circular saw 121, which is a type of a circular cutter tool, may be rotated by a motor (not shown) powered by the batteries 110 which may function as a power source. The circular saw 121 may be vertically arranged, and the motor may be arranged such that its rotation center line is parallel to the rotation center line of the circular saw 121, A base 151 may divide the circular saw 121 into an upper region and a lower region. The base 151 may be pressed from above against wood (not shown) as a workpiece to be cut by the circular saw 121. The base 151 may accommodate a cutting depth by which the wood is cut by the circular saw 121, On the upper side of the base 151, there may be integrally provided a motor housing 131 arranged to cover the motor, a blade case 122 arranged to cover the upper region of the circular saw 121, and a handle 141 arranged on the motor housing 131 and capable of being grasped during transportation and use of the circular saw for wood working. The handle 141 may be arranged at the upper portion of the motor so as to extend backwards with respect to the cut proceeding direction of the circular saw 121 and downwards, with its longitudinal direction being a direction orthogonal to the rotation center line of the motor.

The front end portion of the blade case 122 may be pivotally connected to the front end portion of the base 151 by means of a hinge portion 123, so that, by raising the handle 141, the circular saw 121, the motor, the motor housing 131, and the blade case 122 may be raised with respect to the base 151 about the hinge portion 123. A movable cover 124 may be additionally provided on the lower side of the base 151 so as to cover the lower region of the circular saw 121, so that the movable cover 124 can be accommodated in the blade case 122 while rotating backwards along the outer periphery of the circular saw 121 from the state shown in the drawing. Thus, when the front end portion of the base 151 is placed on a workpiece, and the woodworking circular saw is pushed forwards in the cut proceeding direction, the front end portion of the movable cover 124 may be pushed backwards as the cutting of the wood proceeds, and the movable cover 124 may be accommodated inside the blade case 122, enabling the circular saw 121 to cut the wood workpiece without being hindered by the movable cover 124.

The batteries 110 may be attached to the front portion of the handle 141 and to the front portion of the motor housing 131 via battery attachment portions (not shown) such that two batteries 110 each with terminal voltage of 18 V may be connected in series. The two batteries 110 may be attached in an inclined state along a forwardly inclined surface at the front portion of the handle 141, and be configured such that as the two batteries 110 may be pushed in the direction indicated by the shaded arrow in FIG. 7, they are connected in series to power source terminals (not shown) of the woodworking circular saw. When the batteries 110 have been attached in this way, two batteries 110 in the left and right directions may be positioned within a width in the left and right directions of the motor housing 131, they protrude forward along the blade case 122, where their upward protrusion amounts may be smaller than the upward protrusion amount of the handle 141. Therefore, the two batteries 110 may not interfere with the operation of the woodworking circular saw.

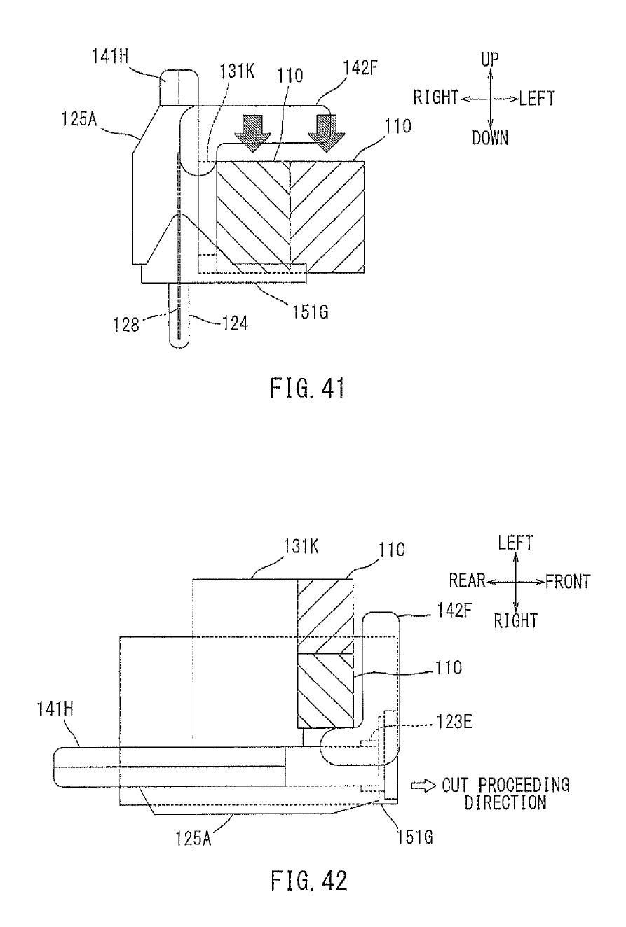

Although not shown in FIGS. 7 through 9, the battery attachment portions may be arranged at the front portion of the motor housing 131. FIG. 41 shows the battery attachment portions in detail. In FIG. 41, two batteries 110 may be attached to a battery attachment portion 160. In order to successfully establish an electrical connection, there may be provided connection terminals 161 and 162 for the two batteries, two pairs of rail receiving portions 163, and claw engaging portions 164. The connection terminals 161 and 162 may be adapted to respectively connect to positive and negative electrodes of each of the battery 110. The rail receiving portions 163 may be adapted to engage rail portions (not shown) provided on side of the batteries 110 correspondingly and may retain the batteries 110 as the batteries 110 are inserted in the direction indicated by the arrows in FIG. 41. The claw engaging portions 164 may be adapted to engage claw portions (not shown) provided on the side of the batteries 110 such that, when the batteries 110 are inserted and retained as described above, the retained state can be maintained. The battery attachment portion 160 may be provided with two battery attachment portions arranged side by side each for one battery in order to accommodate two batteries.

In the second embodiment described above, two 18 V batteries 10 may be used instead of a single 36 V battery for the woodworking circular saw with a rated voltage of 36 V, and therefore, it is possible to use 18 V batteries that may be readily available. Thus, it is possible to use 18 V batteries as in the case of electric tools of low output, making it possible to enhance the convenience in use and handling ability of the woodworking circular saw with a rated voltage of 36 V. Further, the two batteries 110 may be attached to the front portion of the handle 141 and to the front portion of the motor housing 131, so that the attached positions may be spaced away from the handle 141. Even if the space occupied by the batteries may increase as a result of using two batteries 110, the batteries 110 may not constitute an obstruction when grasping the handle 141.

### Third Embodiment

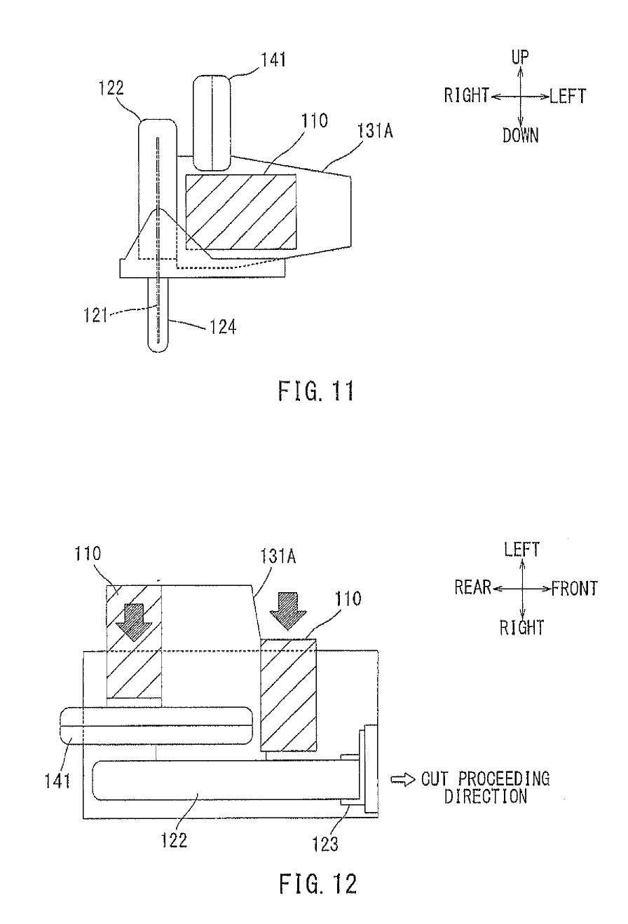

The third embodiment will be described with reference to FIGS. 10 through 12. The third embodiment may differ from the second embodiment in that the attachment positions of the two batteries 110 in the woodworking circular saw may be changed. In other respects, the two embodiments may be identical, so like components are labeled with like reference numerals, and a description of the same will not be repeated. In the woodworking circular saw of the second embodiment, two batteries 110 each with a terminal voltage of 18V may be respectively attached to the front portion and the rear portion of a motor housing 131A so as to be connected in series. Further, the two batteries 110 may be attached so as to be spaced from the handle 141 such that the front battery 110 is spaced apart from the front portion of the handle 141 and that the rear battery 110 is spaced from a lateral portion of the handle 141. Here, the left-hand side end of the rear battery 110 may be positioned to align with the left side end of the motor housing 131A, and the front battery 110 may be displaced to the right from the rear battery 110. Further, the motor housing 131A may be of a different configuration from the motor housing 131 of the first embodiment in order that the batteries 110 can be easily attached to the front portion and the rear portion. In this embodiment, although not shown, the battery attachment portions, each for one battery, may be respectively provided at the front portion and the rear portion of the motor housing 131A, because the two batteries 110 are attached while separated to the front and rear sides of the motor housing 131A.

The two batteries 110 may be connected in series to the power source terminals (not shown) of the woodworking circular saw as they are pushed in the direction indicated by the shaded arrows in FIG. 12, When the batteries 110 are attached in this way, the two batteries 110 in the left and right directions may be within the width in the left and right directions of the motor housing 131A, and they may protrude forward, backward, and upward along the blade case 122. Therefore, the two batteries 110 may not interfere with the operation using the woodworking circular saw.

### Fourth Embodiment

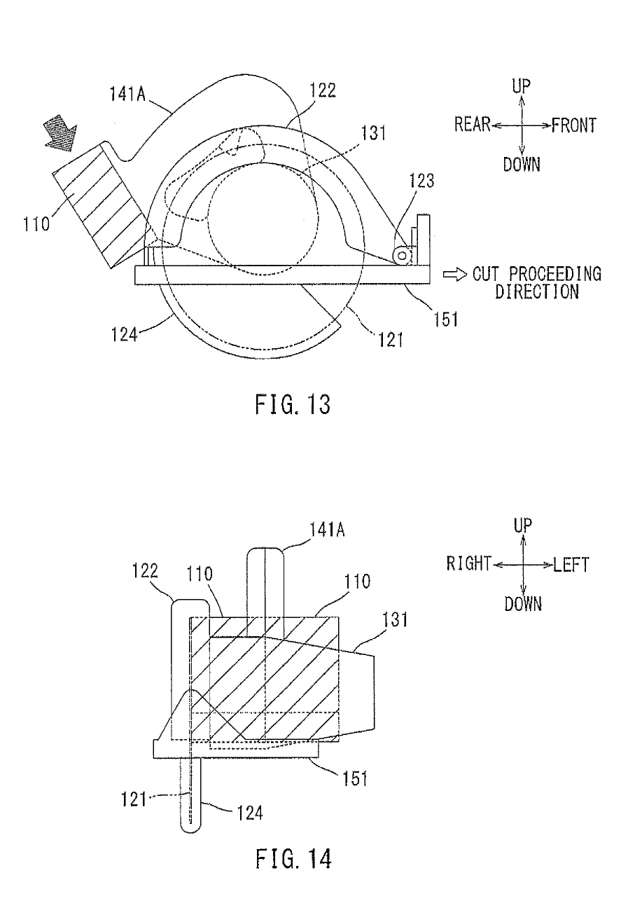

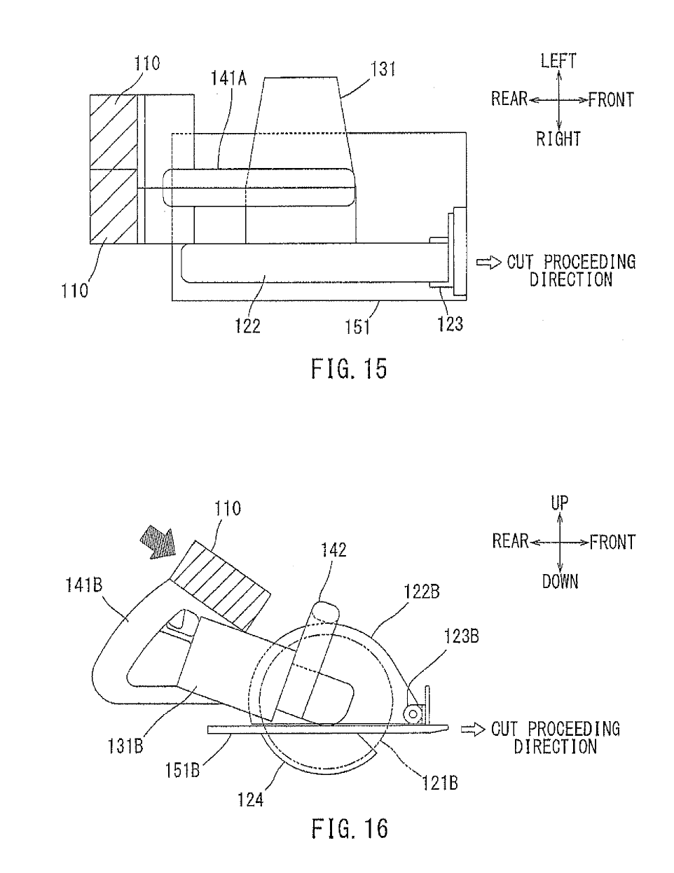

The fourth embodiment will be described with reference to FIGS. 13 through 15. The features of the fourth embodiment as compared with the second embodiment may be different. Namely, the attachment positions of the two batteries 110 in the woodworking circular saw may be changed. With regard to the remaining features, the second and fourth embodiments may be substantially the same, so like components are labeled with like reference numerals and a description of the same will be omitted. In the woodworking circular saw of the fourth embodiment, the two batteries 110 each of a terminal voltage of 18 V may be attached to the rear portion of the handle 141 so that they may be connected in series. As shown in FIGS. 13 and 15, in order to attach the batteries 110, the rear portion of the handle 141 may be formed with a relatively large width, and battery attachment portions (not shown) similar to those of the second embodiment may be disposed at this portion.

As the two batteries 110 may be pushed in the direction indicated by the shaded arrow in FIG. 13, the two batteries 110 may be connected in series to the power source terminals (not shown) of the woodworking circular saw. When the batteries 110 may be attached in this way, the two batteries 110 in the left-to-right direction may be within the width in the left-to-right direction of the motor housing 131, Although the two batteries may protrude backwards, they may protrude upward along the extension of the downwardly inclined line of a handle 141A. Therefore, the two batteries 110 may not interfere with the operation using the circular saw for woodworking.

### Fifth Embodiment

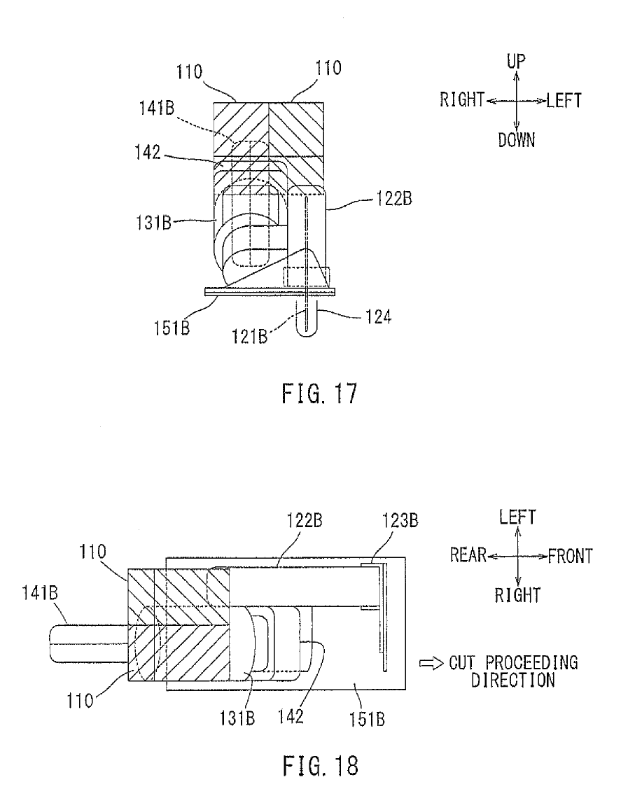

The fifth embodiment will be described with reference to FIGS. 16 through 18. The fifth embodiment relates to a motor/cutter parallel type circular saw for woodworking. The woodworking circular saw may be of a rated voltage of 36 V, and may use two 18 V batteries connected in series as a power source. The fifth embodiment may be similar to a conventionally well-known motor/cutter parallel type circular saw for woodworking, with the exception that two batteries 110 may be connected in series. A detailed description of a conventional woodworking circular saw will be omitted.

The woodworking circular saw of this embodiment may be configured such that a circular saw 121B, which is a type of a circular cutter tool, may be rotated by a motor (not shown) powered by the batteries 110 as the power source. The circular saw 121B may be vertically arranged, and the motor may be arranged such that its rotation center line is orthogonal to the rotation center line of the circular saw 121B, A base 151b may divide the circular saw 121B into the upper and lower regions. The base 151B may be pressed from above against wood (not shown) as a workpiece to be cut by the circular saw 121B. The base 151B may accommodate a cutting depth by which the wood is cut by the circular saw 121B. On the upper side of the base 151B, there may be integrally provided a motor housing 131B arranged to cover the motor, a blade case 122B arranged to cover the upper region of the circular saw 121B, and a rear handle 141B and a front handle 142 that can be grasped during transportation and use of the woodworking circular saw. The motor may be arranged such that its rotation center axis is inclined with respect to the base 151B. The motor housing 131B may be formed in a cylindrical configuration along the contour of the motor. The rear handle 141B may be integrally provided at the rear end of the motor housing 131B so as to form a backwardly swollen ring. The front handle 142 may be integrally provided at the front end of the motor housing 131B so as to form a ring of a configuration orthogonal to the ring configuration of the rear handle 141B.

The front end portion of the blade case 122B may be pivotally connected to the front end portion of the base 151B by means of a hinge portion 123B, so that, raising the rear handle 141B may raise the circular saw 121B, the motor, the motor housing 131B, and the blade case 122B with respect to the base 151B about the hinge portion 123B. In the woodworking circular saw of this embodiment, the movable cover 124 may be additionally provided on the lower side of the base 151B so as to cover the lower region of the circular saw 121B, so that the movable cover 124 can be accommodated inside the blade case 122B while backwardly rotating along the outer periphery of the circular saw 121B from the state shown in the drawing, Thus, when the front end portion of the base 151B is placed on the workpiece, and the woodworking circular saw is pushed forwards in the cut proceeding direction, the front end portion of the movable cover 124 may be pushed backwards as the cutting of the wood proceeds, and the movable cover 124 may be accommodated inside the blade case 122B. In this way, the circular saw 121B can cut the wood without being hindered by the movable cover 124.

The batteries 110 may be attached to the front portion of the handle 141 and to the upper portion of the motor housing 131B via battery attachment portions similar to those of the second embodiment (not shown) such that two batteries 110 each with the terminal voltage of 18 V may be connected in series. The two batteries 110 may be attached in an inclined state along a forwardly inclined surface at the front portion of the handle 141B. The two batteries 110 may be connected in series to the power source terminals (not shown) of the woodworking circular saw as they are pushed in the direction indicated by the shaded arrow in FIG. 16. When the batteries 110 are attached in this way, the two batteries 110 in the left-to-right direction may be within the width in the left-to-right direction of the base 151B, the two batteries in the front-to-rear direction may be within the range of the length in the front-to-rear direction of the rear handle 141B and the motor housing 131B. The upward protrusion amounts of the batteries 110 may be slightly larger than the inherent upward protrusion amount of the handle 141B. The upward protrusion amounts of the batteries 110 may be suppressed by forming an inclined surface at the front upper portion of the rear handle 141B for the fixation of the batteries 110. Therefore, the two batteries 110 may not interfere with the operation using the woodworking circular saw.

### Sixth Embodiment

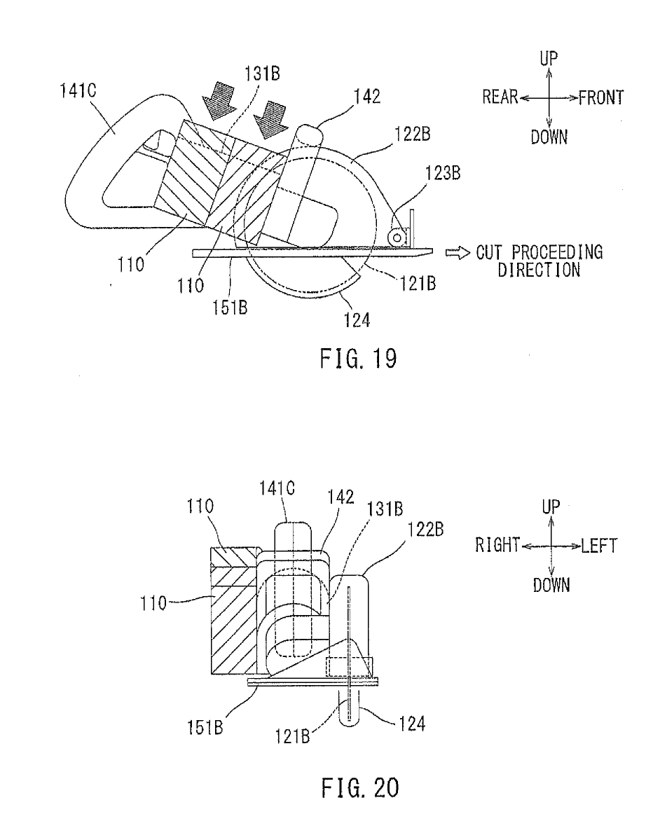

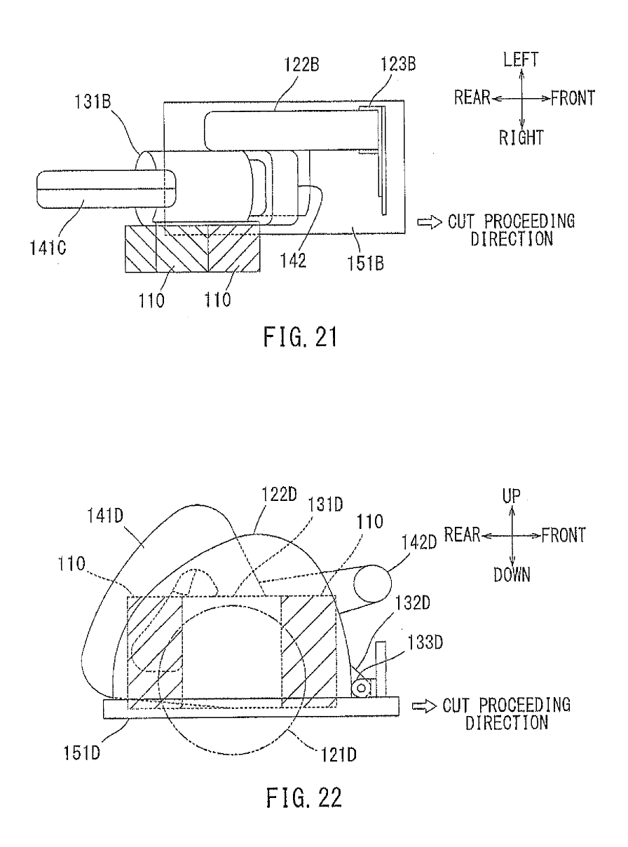

The sixth embodiment will be described with reference to FIGS. 19 through 21. The features of the sixth embodiment as compared with the fifth embodiment may be different. Namely, the attachment positions of the two batteries 110 in the woodworking circular saw may be changed. In other respect the two embodiments may be the same, so like components are labeled with like reference numerals and a description of the same will be omitted. A rear handle 141C may be slightly changed in configuration as compared with the rear handle 141B of the fifth embodiment. In the woodworking circular saw of the sixth embodiment, two batteries 110 each with a terminal voltage of 18 V may be attached to a lateral portion of the motor housing 131E on the side opposite to the side of a circular saw 121B via battery attachment portions (not shown) similar to those of the second embodiment in such a manner that the batteries are connected in series.

As the two batteries 110 may be pushed in the direction indicated by the shaded arrows in FIG. 19, the two batteries 110 may be connected in series to the power source terminals (not shown) of the woodworking circular saw. When the batteries 110 may be attached in this way, the two batteries 110 in the left-to-right direction may protrude from the right end of a base 151B approximately by the thickness of the batteries 110, whereas, in the front-to-rear direction, the batteries 110 may be within the layout range of the front handle 142 and the rear handle 141C. Also in the vertical direction, the batteries 110 may be within the layout range of the motor housing 131B and the front and rear handles 142 and 141C. Therefore, the two batteries 110 may not interfere with the operation using the woodworking circular saw.

### Seventh Embodiment

The seventh embodiment will be described with reference to FIGS. 22 through 24. The seventh embodiment relates to a circular saw for woodworking called a plunge cut saw. The circular saw of this embodiment may be configured to enable a circular saw 121D to move also from above with respect to wood (not shown) as a workpiece. The woodworking circular saw may be of a rated voltage of 36 V and may use as a power source two 18 V batteries 110 connected in series. The circular saw of the sixth embodiment may be substantially the same as a conventionally well-known plunge type circular saw for woodworking, with the exception that two batteries 110 may be connected in series. A detailed description of the conventional wood working circular saw will be omitted.

The woodworking circular saw of this embodiment may be configured such that a circular saw 121D, which is a type of a circular cutter tool, may be rotated by a motor (not shown) powered by the batteries 110 as the power source. The circular saw 121D may be vertically arranged, and the motor may be arranged such that its rotation center line is parallel to the rotation center line of the circular saw 121D. A base 151D may divide the circular saw 121D into the upper region and the lower region. The base 151D may be pressed from above against wood (not shown) as a workpiece to be cut by the circular saw 121D, The base 151D may accommodate a cutting depth by which the wood is cut by the circular saw 121D. On the upper side of the base 151D, there may be integrally provided a motor housing 131D arranged to cover the motor, a blade case 122D arranged to cover the upper region of the circular saw 121D, and a rear handle 141D and a front handle 142D that may be arranged on the motor housing 131 and may be grasped during transportation and use of the circular saw for wood working. Here, the blade case 122D and the base 151D may be integrated together, and the circular saw 121D, the motor, the motor housing 131D, the rear handle 141D and the front handle 142 may be integrated together. The rear handle 141D may be arranged at the rear portion of the motor so as to extend backwards and downwards from the motor, with its longitudinal direction being a direction crossing the rotation center line of the motor. The front handle 142D may be arranged at the front portion of the motor so as to extend to a side opposite to the circular saw 121D with respect to the rear handle 141D, with its longitudinal direction being a direction parallel to the rotation center line of the motor.

A bracket 132D may be integrally provided at the front portion of the motor housing 131D and may extend forwards. The front end portion of the bracket 132D may be pivotally connected to the front end portion of the base 151D by means of a hinge portion 133D, so that, raising the rear handle 141D may raise the circular saw 121D, the motor and the motor housing 131D with respect to the base 151 about the hinge portion 133D. The blade case 122D may have a height enough in the upward direction in order to prevent interference of the circular saw 121D with the inner wall of the blade case 122D when the circular saw 121D is raised, Therefore, the circular saw 121D may be raised by grasping the rear handle 141D and may cut the workpiece below the base 151D. The rear handle 141D and the front handle 142D may be pushed forwards to continue to cut the workpiece in the cut proceeding direction by the circular saw 121D.

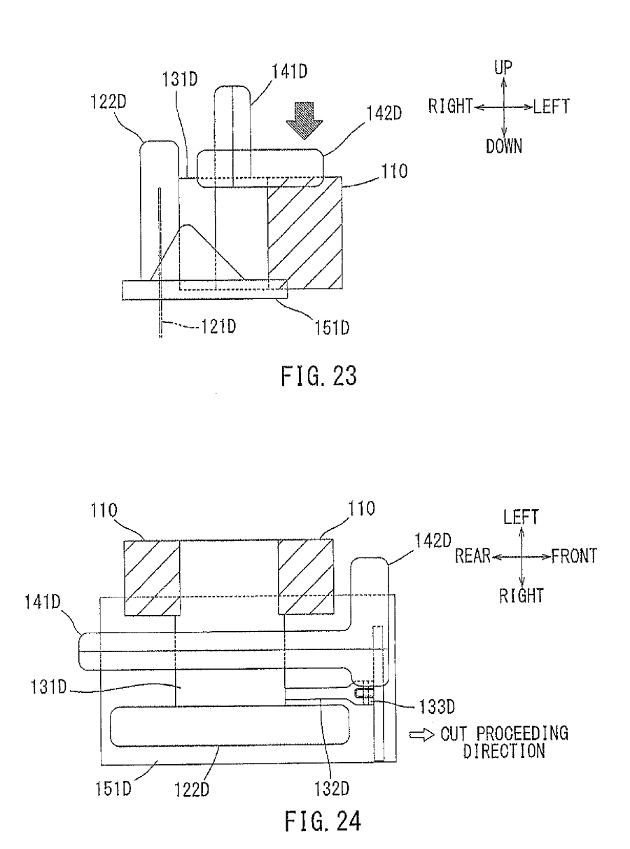

The batteries 110 may be respectively attached to the front portion and the rear portion of the motor housing 131D via battery attachment portions (not shown) similar to those of the third embodiment, such that two batteries 110 each with terminal voltage of 18 V may be connected in series. The rear battery 110 may be attached on the side opposite to the side of the circular saw 121D with respect to the rear handle 141D so as to be spaced away from the rear handle 141D. The front battery 110 may be attached on the rear side of front handle 142D so as to be spaced away from the front handle 142D. As the two batteries 110 may be pushed in the direction indicated by the shaded arrow of FIG. 23, the two batteries 110 may be connected in series to the power source terminals (not shown) of the woodworking circular saw. When the batteries 110 may be thus attached, the two batteries 110 in the left and right directions may be within the width in the right and left directions of the motor housing 131D. The batteries 110 in the front and rear directions and in the vertical direction may be within the shape of the blade case 122D, Therefore, the two batteries 110 may not interfere with the operation using the woodworking circular saw.

### Eighth Embodiment

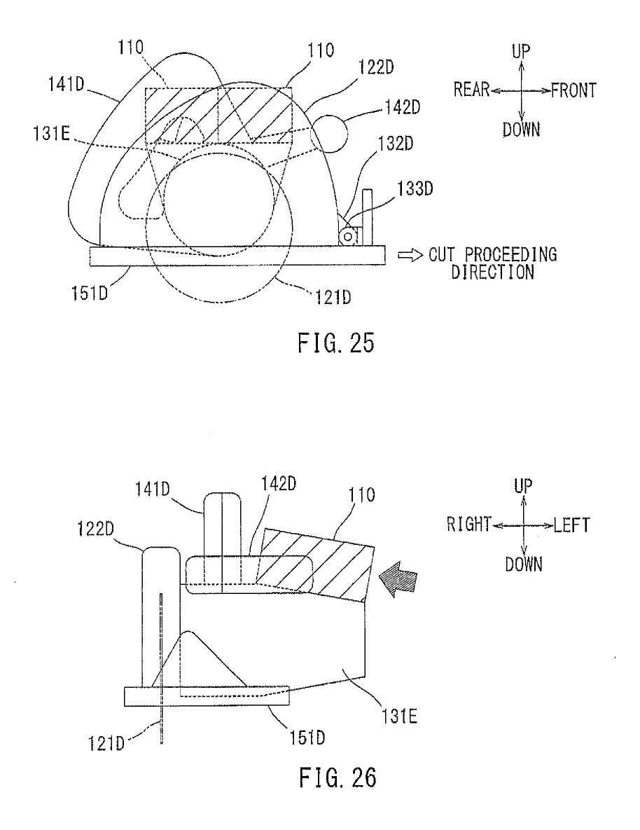

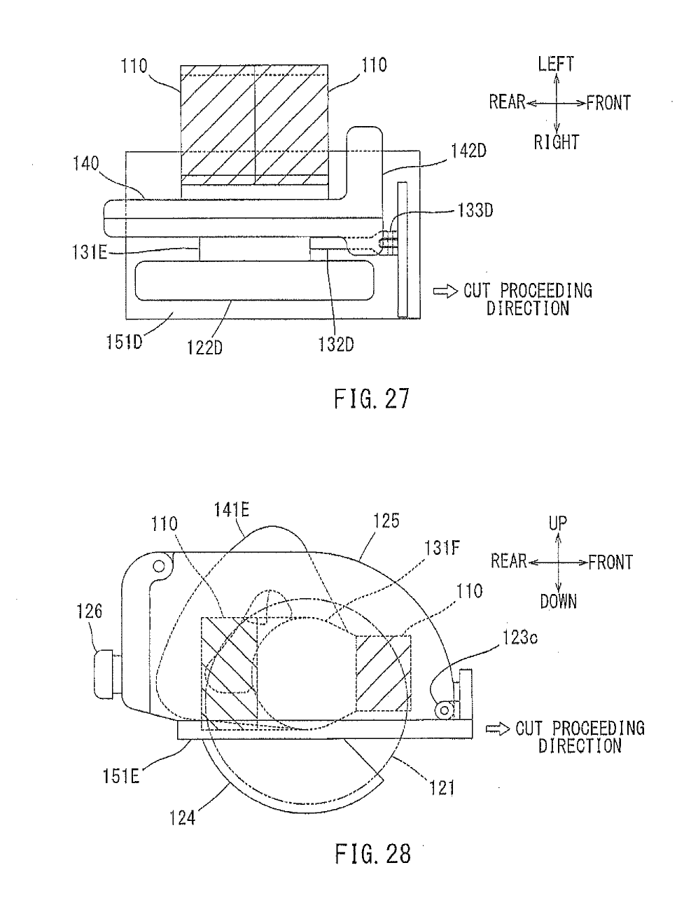

The eighth embodiment will be described with reference to FIGS. 25 through 27. The features of the eighth embodiment as compared with the seventh embodiment may be different, Namely, the attachment positions of the two batteries 110 in the woodworking circular saw may be changed. In other respects, the seventh and eighth embodiments may be substantially the same, so like components are labeled with like reference numerals and a description of the same will be omitted. As compared with the motor housing 131D of the seventh embodiment, a motor housing 131E may be slightly changed in configuration. In the woodworking circular saw of the eighth embodiment, the batteries 110 may be attached to the upper portion of a motor housing 131E via battery attachment portions (not shown) similar to those of the second embodiment such that two batteries 110 each with terminal voltage of 18 V may be connected in series, with the batteries attached on the side opposite to the circular saw 121D with respect to the rear handle 141D and on the rear side of the front handle 142D so as to be spaced away from the rear handle 141D and the front handle 142D.

The two batteries 110 may be configured such that they may be connected in series to the power source terminals (not shown) of the woodworking circular saw as the two batteries 110 are pushed in the direction indicated by the shaded arrow of FIG. 26, When the batteries 110 may be attached in this way, the two batteries 110 in the left-to-right direction may be within the width in the left-to-right direction of the motor housing 131E, whereas, in the front-to-rear direction, the two batteries 110 may be—within the layout range of the front handle 142D and the rear handle 141D. Also in the vertical direction, they may be within the width in the vertical direction of the rear handle 141D, Therefore, the two batteries 110 may not interfere with the operation using the woodworking circular saw.

### Ninth Embodiment

The ninth embodiment will be described with reference to FIGS. 28 through 30. The ninth embodiment relates to a circular saw for woodworking, where the circular saw may have a dust box. The woodworking circular saw of this embodiment may be of a rated voltage of 36 V and may use 18 V batteries 110 connected in series as a power source. The ninth embodiment may be identical with a conventionally well-known circular saw for woodworking having a dust box, with the exception that the two batteries 110 may be used while connected in series. Thus, a detailed description of the conventional woodworking circular saw will be omitted.

The woodworking circular saw of this embodiment may be configured such that a circular saw 121, which is a type of circular cutter tool, may be rotated by a motor (not shown) powered by the batteries 110 as the power source. The circular saw 121 may be vertically arranged. The motor may be arranged such that its rotation center line is parallel to the rotation center line of the circular saw 121. A base 151E may divide the circular saw 121 into the upper region and the lower region. The base 151E may be pressed from above against wood (not shown) as a workpiece to be cut by the circular saw 121. The base 151E may accommodate a cutting depth by which the wood is cut by the circular saw 121. On the upper side of the base 151E, there may be integrally provided a motor housing 131F arranged to cover the motor, a dust box 125 arranged so as to cover the upper region of the circular saw 121 and as to receive the cutting chips of the wood cut by the circular saw 121, and a handle 141E arranged on the motor housing 131F and capable of being grasped during transportation and use of the woodworking circular saw. The handle 14W may be arranged at the upper portion of the motor so as to extend backwards in the cut proceeding direction of the circular saw 121 and downwards, with its longitudinal direction being a direction orthogonal to the rotation center line of the motor. At the rear end portion of the dust box 125, there may be arranged a dust collector connection port 126 for discharging the cutting chips received in the dust box 125 to the outside.

The front end portion of the dust box 125 may be pivotally connected to the front end portion of the base 151E by means of a hinge portion 123, so that raising the handle 41 may raise the circular saw 121, the motor, the motor housing 131F, and the dust box 125 with respect to the base 151E about the hinge portion 123. In the case of this woodworking circular saw of this embodiment, a movable cover 124 may be additionally provided on the lower side of the base 151E so as to cover the lower region of the circular saw 121, so that the movable cover 124 can be accommodated in the dust box 125 while rotating backwards along the outer periphery of the circular saw 121 from the state shown in the drawing, Thus, when the front end portion of the base 151E may be placed on the wood as the workpiece, and the woodworking circular saw may be pushed forwards in the cut proceeding direction, the front end portion of the movable cover 124 may be pushed backwards as the cutting of the wood proceeds, and the movable cover 124 may be accommodated inside the dust box 125, thereby enabling the circular saw 121 to cut the workpiece without being hindered by the movable cover 124.

The batteries 110 may be respectively attached to the front portion and the rear portion of the motor housing 131E via battery attachment portions (not shown) similar to those of the third embodiment such that two batteries 110 each with terminal voltage of 18 V may be connected in series. The front battery 110 may be attached on the side of handle 141E and on the side of a lateral portion of the handle 141E so as to be spaced away from the handle 141E, Here, the front battery 110 may be attached such that its longitudinal direction extends in the left-to-right direction, and the rear battery 110 may be attached such that its longitudinal direction extends in the vertical direction.

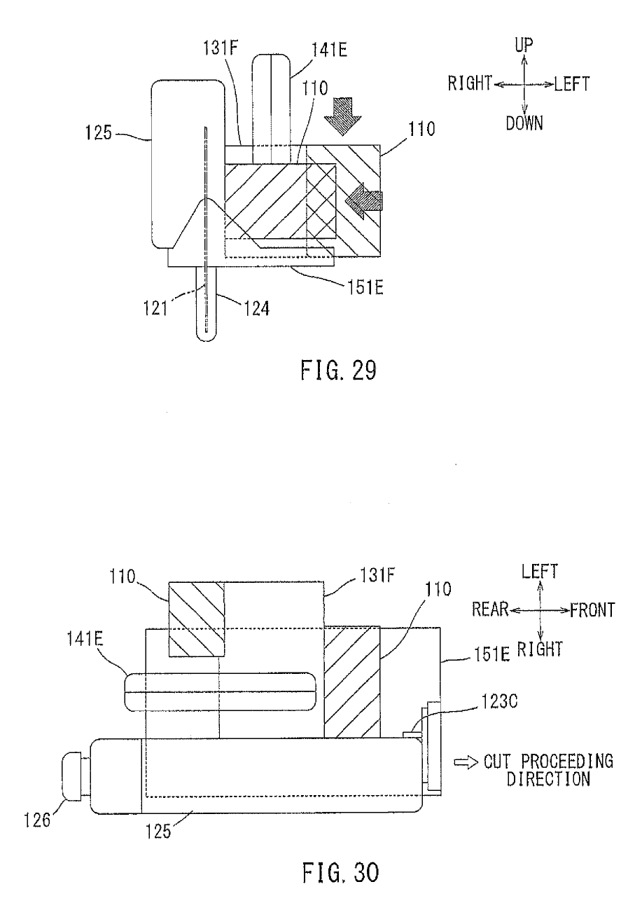

The two batteries 110 may be configured such that the two batteries 110 may be connected in series to the power source terminals (not shown) of the woodworking circular saw as the two batteries 110 are pushed in the direction indicated by the shaded arrow of FIG. 29. When the batteries 110 may be attached in this way, the two batteries 110 in the left-to-right direction may be within the width in the left-to-right direction of the motor housing 131F, In the front-to-rear direction, the batteries 110 may be within the length in the front-to-rear direction of the base 151E. Also in the vertical direction, the batteries 110 may be within the width in the vertical direction of the motor housing 131F. Therefore, the two batteries 110 may not interfere with the operation using the woodworking circular saw.

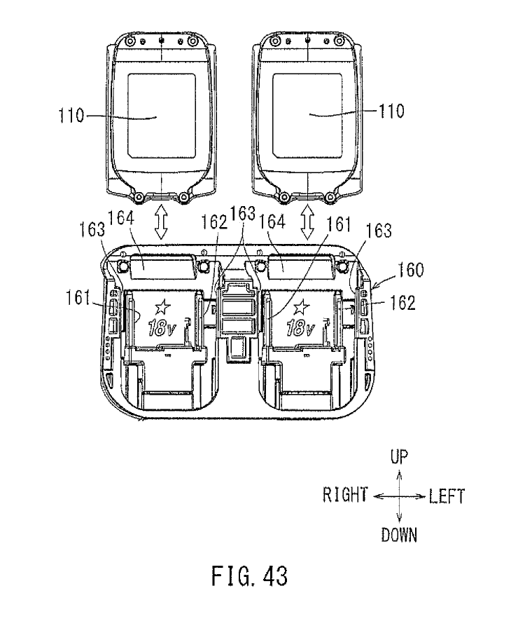

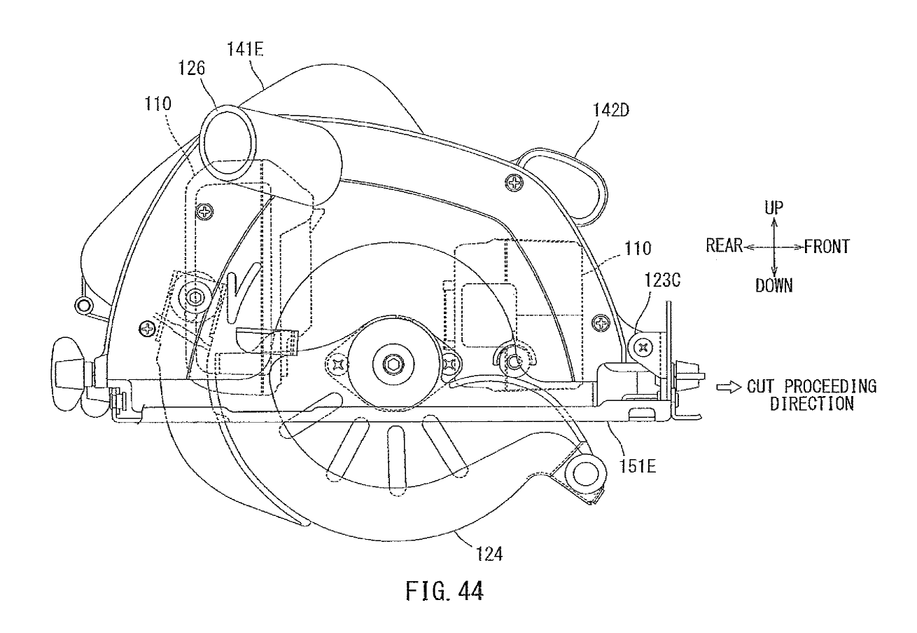

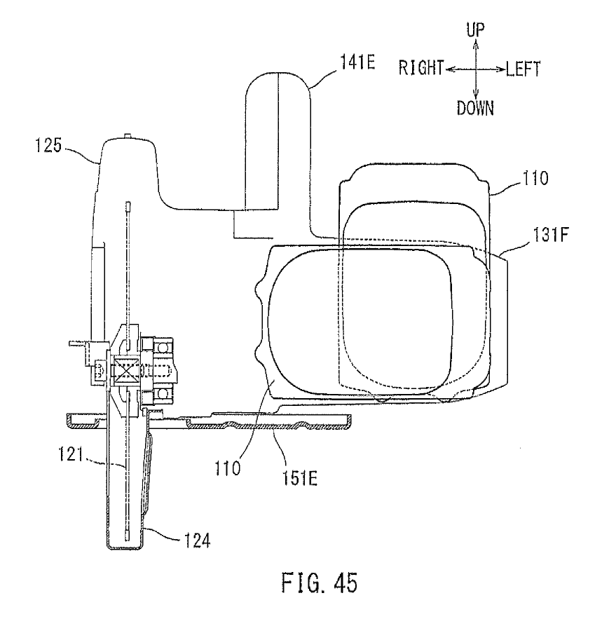

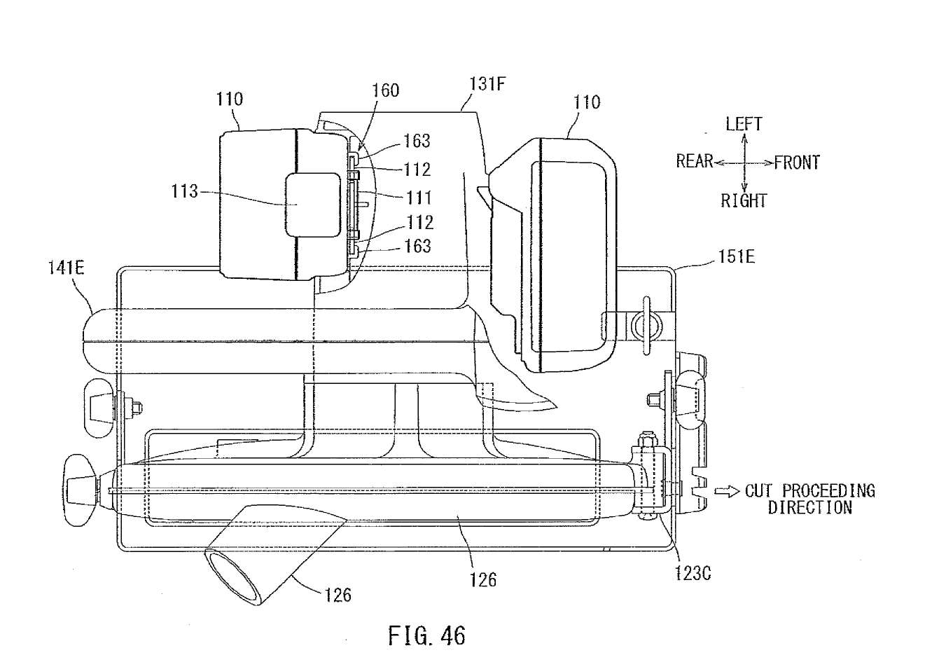

Referring to FIGS. 42 through 46, an example of the application of the ninth embodiment to a traditional woodworking circular saw is shown. In FIGS. 42 through 46, portions corresponding to those of FIGS. 28 through 30 are labeled with like reference numerals, and a redundant description of the same will be omitted. In FIG. 42, the circular saw 121 is not shown to enable easy understanding of the construction of the movable cover 124. As may be apparent from FIGS. 42 and 46, in this example, the dust collector connection port 126 may be situated at the right upper portion of the dust box 125. In FIG. 45, however, the dust collector connection port 126 is not shown. Further, as shown in FIG. 42, in this example, the front handle 142D may be provided similar to the seventh embodiment described with reference to FIG. 22. In FIGS. 45 and 46, however, the front handle 142D is not shown.

FIG. 46 illustrates a battery attachment portion 160 for the battery 110 attached to the rear portion of the motor housing 131F. As shown here, rail portions 112 provided on the side of the battery 110 may engage a pair of rail receiving portions 163 provided on side of the motor housing 131F, Further, a claw portion 111 may be positioned at the surface of the battery 110 on the side of the motor housing 131F. Depressing a button 113 disposed at the end surface of the battery 110 may release the engagement of the claw portion 111 with a claw engaging portion (not shown) on the side of the motor housing 131F. FIG. 46 illustrates where the battery 110 may be attached to the rear portion of the motor housing 131F, with the rail portions 112 on the battery 110 side engaged with the pair of the rail receiving portions 163 on the motor housing 131F side, and with the claw portion 111 on the battery 110 side engaged with the claw engaging portion on the motor housing 131F side.

### Tenth Embodiment

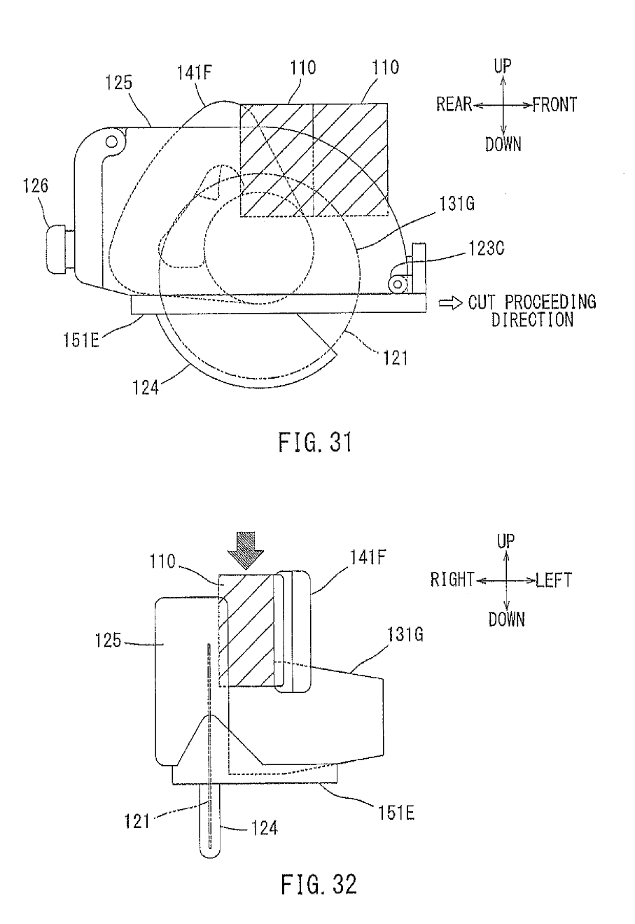

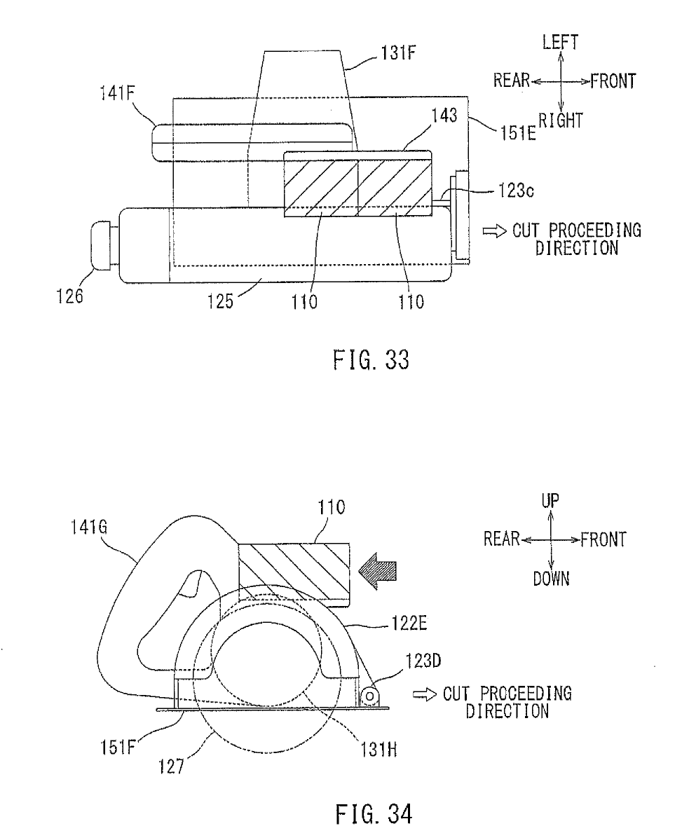

The tenth embodiment will be described with reference to FIGS. 31 through 33. The features of the tenth embodiment as compared with the ninth embodiment may be different. Namely, the attachment positions of the two batteries 110 in the woodworking circular saw may be changed. In other respects, the ninth and tenth embodiments may be substantially the same, so like components are labeled with like reference numerals and a description of the same will be omitted. As compared with the motor housing 131F and the handle 141E of the ninth embodiment, a motor housing 131G and a handle 141F may be slightly changed in configuration. In the woodworking circular saw of the tenth embodiment, the batteries 110 each with a terminal voltage of 18 V may be attached to front side portions of the handle 141F and the dust box 125 so as to be positioned between the handle 141F and the dust box 125 via battery attachment portions (not shown) similar to those of the second embodiment such that two batteries 110 may be connected in series. Here, in order to make it easier for the batteries 110 to be fixed to the front side portion, the handle 141F may have a flange portion 143 formed by forwardly extending a wall surface of the handle 141F on the side of the dust box 125.

The two batteries 110 may be configured such that they may be connected in series to the power source terminals (not shown) of the woodworking circular saw as the two batteries 110 may be pushed in the direction indicated by the shaded arrow of FIG. 32, When the batteries 110 may be attached in this way, the two batteries 110 in the left-to-right direction may be received between the handle 141F and the dust box 125. In the front-to-rear direction, the two batteries 110 may be within a length in the front-to-rear direction of the base 151E. In the vertical direction, the two batteries 110 may be within the width in the vertical direction of the handle 141F, Therefore, the two batteries 110 may not interfere with the operation using the woodworking circular saw.

### Eleventh Embodiment

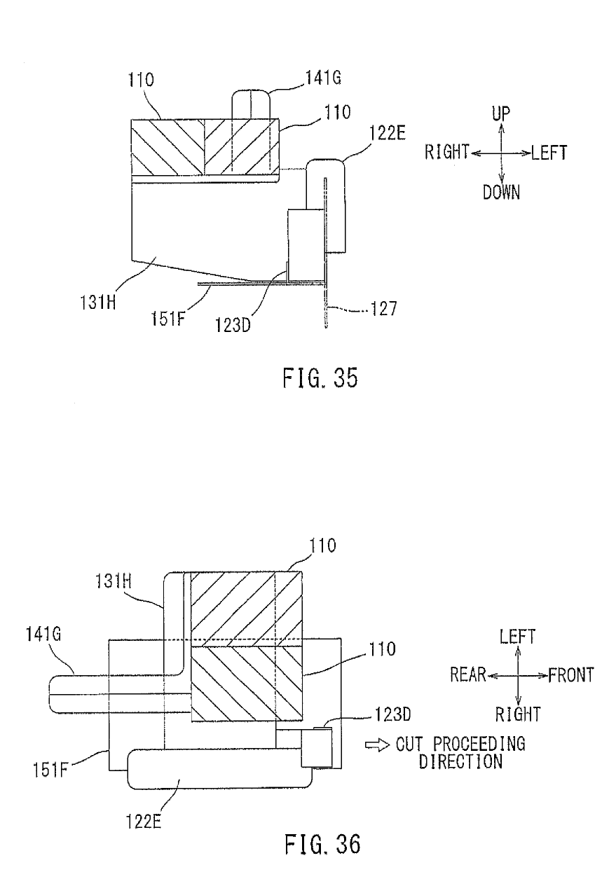

The eleventh embodiment will be described with reference to FIGS. 34 through 36. The eleventh embodiment relates to a cutter for working stone. The stone-working cutter of this embodiment may be of a rated voltage of 36 V, and may use two 18 V batteries 110 connected in series as a power source. The eleventh embodiment may be substantially identical with a conventionally well-known stone-working cutter, with the exception that the two batteries 110 may be connected in series. A detailed description of a conventional stone-working cutter will be omitted.

The stone-working cutter may be configured such that a diamond wheel 127, which is a type of a circular cutter tool, may be rotated by a motor (not shown) powered by the batteries 110 as the power source. The diamond wheel 127 may be vertically arranged. The motor may be arranged such that its rotation center line is parallel to the rotation center line of the diamond wheel 127. A base 151F may divide the diamond wheel 127 into the upper region and the lower region. The base 151F may be pressed from above against stone (not shown) as a workpiece to be cut by the diamond wheel 127. The base 151F may accommodate a cutting depth by which the stone is cut by the diamond wheel 127. On the upper side of the base 151F, there may be integrally provided a motor housing 131H arranged to cover the motor, a blade case 122E arranged to cover the upper region of the diamond wheel 127, and a handle 141G arranged to extend from the upper portion to the rear portion of the motor housing 131H and capable of being grasped during transportation and use of the stone working cutter. The handle 141G may extend from the upper portion to the rear portion of the motor housing 13111 and may be arranged so as to extend backwards in the cut proceeding direction of the diamond wheel 127 and downwards, with its longitudinal direction being a direction orthogonal to the rotation center line of the motor. The front end portion of the blade case 122E may be pivotally connected to the front end portion of the base 151F by means of a hinge portion 123D, so that, raising the handle 141G may raise the diamond wheel 127, the motor, the motor housing 131H, and the blade case 122E with respect to the base 151F about the hinge portion 123D.

The batteries 110 may be attached to the upper portion of the motor housing 131H on the front side of the handle 141G via battery attachment portions (not shown) similar to those of the first embodiment such that two batteries 110 each with terminal voltage of 18 V may be connected in series. The two batteries 110 may be connected in series to power source terminals (not shown) of the stone-working cutter as the two batteries 110 are pushed in the direction indicated by the shaded arrow in FIG. 34. When the batteries 110 have been attached in this way, two batteries 110 in the left-to-right direction may be within a width in the left-to-right direction of the motor housing 13111 In the front-to-rear direction, the two batteries 110 may be are within the length in the front-to-rear direction of the handle 141G. In the vertical direction, the two batteries 110 may be within the width in the vertical direction of the handle 141G. Therefore, the two batteries 110 may not interfere with the operation using the stone-working cutter. The woodworking circular saw of the first embodiment may be replaced with the stone-working cutter

### Twelfth Embodiment

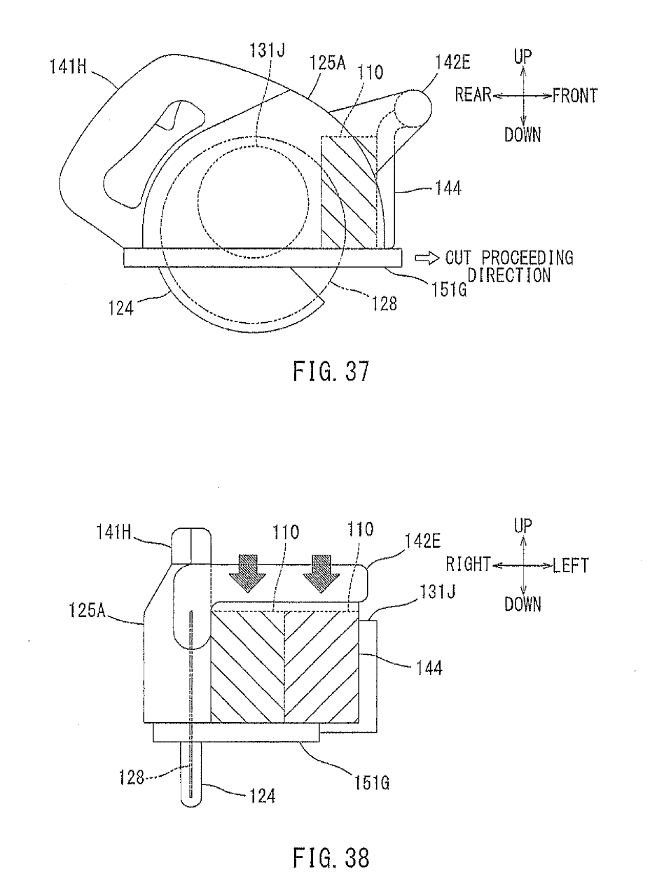

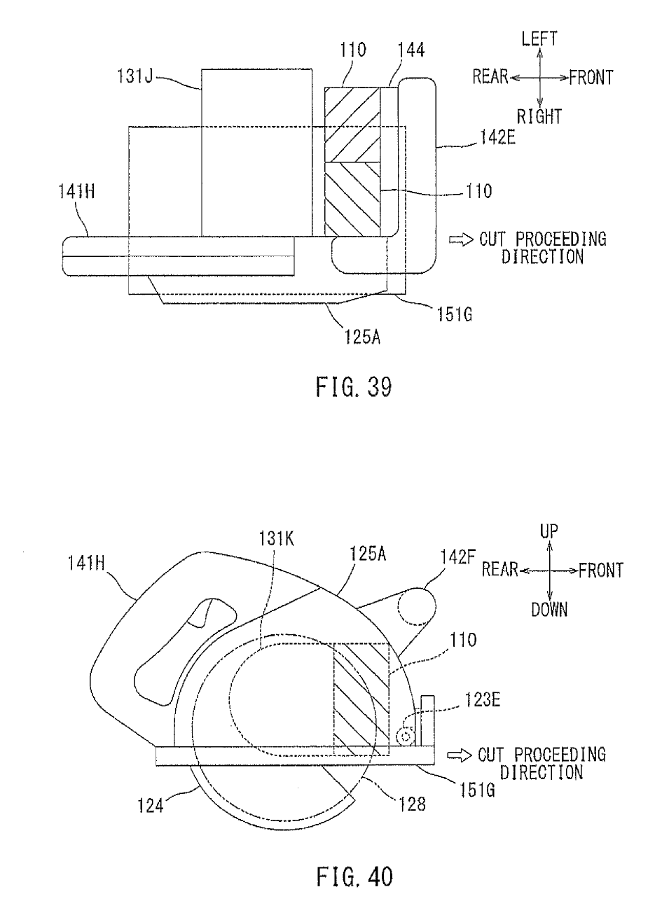

The twelfth embodiment will be described with reference to FIGS. 37 through 39. The twelfth embodiment relates to a tipped saw cutter for working metal. The metalworking tipped saw cutter of this embodiment may be of a rated voltage of 36 V, and may use two 18 V batteries 110 connected in series as a power source. The twelfth embodiment may be substantially identical with a conventionally well-known metalworking tipped saw cutter, with the exception that the two batteries 110 may be connected in series. Therefore a detailed description of a conventional metalworking cutter will be omitted.

The metalworking tipped saw cutter may be configured such that a tipped saw 128, which is a type of a circular cutter tool, may be rotated by a motor (not shown) powered by the batteries 110 as the power source. The tipped saw 128 may be vertically arranged. The motor may be arranged such that its rotation center line is parallel to the rotation center line of the tipped saw 128. A base 151G may divide the tipped saw 128 into the upper region and the lower region. The base 151G may be pressed from above against metal (not shown) as a workpiece to be cut by the tipped saw 128. The base 152G may accommodate a cutting depth by which the metal is cut by the tipped saw 128. On the upper side of the base 151G, there may be integrally provided a motor housing 131J arranged to cover the motor, a dust box 125A arranged so as to cover the upper region of tipped saw 128 and as to receive the cutting chips of the metal out by the tipped saw 128, and a rear handle 141H and a front handle 142E arranged along a region from the upper portion to the rear portion of the dust box 125A and capable of being grasped during transportation and use of the metal working tipped saw cutter. The rear handle 141H may be arranged at the rear portion of the dust box 125A and may extend backwards and downwards of the motor. The front handle 142E may be arranged at the front portion of the dust box 125A and may extend to the side of the motor housing 131J with respect to the rear handle 141H, with its longitudinal direction being a direction parallel to the rotation center line of the motor.

In the case of this metalworking tipped saw cutter of this embodiment, a movable cover 124 may be additionally provided on the lower side of the base 151G so as to cover the lower region of the tipped saw 128, so that the movable cover 124 can be accommodated in the dust box 125A while rotating backwards along the outer periphery of the tipped saw 128 from the state shown in the drawing. Thus, when the front end portion of the base 151G may be placed on the metal as the workpiece, and the metalworking tipped saw cutter may be pushed forwards in the cut proceeding direction, the front end portion of the movable cover 124 may be pushed backwards by the metal as the cutting of the metal proceeds, and the movable cover 124 may be accommodated inside the dust box 125A, thereby enabling the tipped saw 128 to cut the metal without being hindered by the movable cover 124.

The batteries 110 may be attached to the rear portion of the front handle 142E at a position on the front side of the motor housing 131J and spaced away from a grip portion of the front handle 142E, via battery attachment portions (not shown) similar to those of the second embodiment such that two batteries 110 each with terminal voltage of 18 V may be connected in series. On the lower side of the front handle 142E, a vertical wall 144 may be formed so as to extend to reach the base 151G, The batteries 110 may be attached by using the vertical wall 144. The two batteries 110 may be connected in series to the power source terminals (not shown) of the metalworking tipped saw cutter as the two batteries 110 may be pushed in the direction indicated by the shaded arrow of FIG. 38. When the batteries 110 may be attached in this way, the two batteries 110 in the left-to-right direction may be within the width in the left-to-right direction of the motor housing 131J. In the front-to-rear direction, the two batteries 110 may be received between the vertical wall 144 and the motor housing 131J. In the vertical direction, the two batteries 110 may be within the width in the vertical direction of the dust box 125A, Therefore, the two batteries 110 may not interfere with the operation using the metalworking tipped saw cutter. The twelfth embodiment may be different from the second embodiment described above only in the change from the woodworking circular saw to the metalworking tipped saw cutter.

### Thirteenth Embodiment

The thirteenth embodiment will be described with reference to FIGS. 40 through 42, The thirteenth embodiment may differ from the twelfth embodiment in that the attachment positions of the two batteries 110 in the metalworking tipped saw cutter may be changed. In other respects, the twelfth and thirteenth embodiments may be substantially identical with each other, so like components are labeled with like reference numerals, and a description of the same will be omitted. It should be noted, however, that, due to the change in the attachment positions of the batteries 110, there may be some differences between the twelfth embodiment and the thirteenth embodiment. That is, the configuration of a motor housing 131K of the thirteenth embodiment may be changed from that of the motor housing 131J of the twelfth embodiment, A front handle 142F of the thirteenth embodiment may have no vertical wall 144 of the front handle 142E of the twelfth embodiment. Further, between the front end portion of the base 151G and the front lower end portion of the dust box 125A, there may be provided a hinge portion 123E. Regarding the hinge portion 123E, although not shown in FIGS. 37 through 39 of the twelfth embodiment, the twelfth embodiment may include a similar hinge portion as the hinge portion 123E.

In the metalworking tipped saw cutter of the thirteenth embodiment, the batteries 110 may be attached to the front portion of the motor housing 131K via battery attachment portions (not shown) similar to those of the second embodiment such that two batteries 110 each with terminal voltage of 18 V may be connected in series. The attaching positions may be set on the rear side of the front handle 142F and may be spaced from a grip portion of the front handle 142F.

The two batteries 110 may be connected in series to the power source terminals (not shown) of the metalworking tipped saw cutter as the two batteries 110 may be pushed in the direction indicated by the shaded arrow of FIG. 41. When the batteries 110 may be attached in this way, the two batteries 110 in the left-to-right direction may be within the width in the left-to-right direction of the motor housing 131K. In the front-to-rear direction, the two batteries 110 may be received between the front handle 142F and the motor housing 131K. In the vertical direction, the two batteries 110 may be within the width in the vertical direction of the dust box 125A. Therefore, the two batteries 110 may not interfere with the operation using the metalworking tipped saw cutter. The thirteenth embodiment may be different from the second embodiment described above only in the change from the woodworking circular saw to the metalworking tipped saw cutter.

The above second to thirteenth embodiments should not be restricted to the discussed external appearances and constructions as various modifications, additions, and eliminations may be contemplated. For example:

1. While the above embodiments disclose 18 V batteries, batteries of different voltages such as 14.4 V batteries may also be used. Batteries of the same rating voltage as that of widely available batteries may be used.
2. While the above embodiments disclose two batteries connected in series, the number of batteries connected in series may be three or more. The number of batteries may be selected to conform to the rated voltage of a hand-held type electric cutting device such that batteries of the same rating voltage as that of widely available batteries can be used. For example, in the case where widely available batteries are 18 V batteries and where the rated voltage of the hand-held type electric cutting device is 54 V, three 18 V batteries may be used.

What is claimed is:

1. A cutting device comprising:
a base configured to contact with a workpiece to be cut; and
a cutting tool main body supported on an upper surface side of the base, wherein:
the cutting tool main body includes an electric motor, a circular cutting blade rotatably driven by the electric motor, a battery attachment portion configured to be capable of attaching a battery as a power source for the electric motor, and a rear handle;
the circular cutting blade is configured to cut the workpiece as the cutting device moves in a cut proceeding direction while the base contacts the workpiece;
a surface of the circular cutting blade is parallel to the cut proceeding direction;
a rotation center of the electric motor is parallel to the surface of the cut proceeding direction;
the base includes a front end and a rear end with respect to the cut proceeding direction; and
the rear handle is configured to have a shape of a part of a ring and is arranged near the rear end of the base.

2. The cutting device according to claim 1, wherein the cutting tool main body further includes a front handle disposed on a front side of the rear handle with respect to the cut proceeding direction.

3. The cutting device according to claim 2, wherein the battery attachment portion is configured such that the battery attached to the battery attachment portion is positioned between a grip portion of the front handle and a rear end of the rear handle in the cut proceeding direction.

4. The cutting device according to claim 2, wherein the battery attachment portion is configured such that the battery attached to the battery attachment portion is positioned between a grip portion of the front handle and a grip portion of the rear handle in the cut proceeding direction.

5. The cutting device according to claim 1, wherein the battery attachment portion is configured such that the battery attached to the battery attachment portion is positioned between a rotation center of the circular cutting blade and a rear end of the rear handle in the cut proceeding direction.

6. The cutting device according to claim 1, wherein the battery attachment portion is configured such that the battery attached to the battery attachment portion is positioned between a rotation center of the circular cutting blade and a grip portion of the rear handle in the cut proceeding direction.

7. The cutting device according to claim 1, wherein the cutting tool main body further comprises a motor housing configured to house the electric motor, and the battery attachment portion is configured such that the battery attached to the battery attachment portion is disposed on an upper side of the motor housing.

8. The cutting device according to claim 1, wherein the cutting tool main body further comprises a motor housing configured to house the electric motor, and the battery attachment portion is configured such that the battery attached to the battery attachment portion is disposed on an upper side of the rear handle.

9. The cutting device according to claim 1, wherein the cutting tool main body further comprises a motor housing configured to house the electric motor, and the battery attachment portion is configured such that the battery attached to the battery attachment portion is disposed on a lateral side of the motor housing.

10. The cutting device according to claim 9, wherein the cutting tool main body further comprises a blade case configured to cover the cutting blade, and the battery attachment portion is configured such that the battery attached to the battery attachment portion is positioned away from the blade case.

11. A cutting device comprising:
a base configured to contact with a workpiece to be cut; and
a cutting tool main body supported on an upper surface side of the base, wherein:
the cutting tool main body includes a motor housing configured to house an electric motor, a blade case configured to cover a circular cutting blade rotatably driven by the electric motor, a battery attachment portion configured to be capable of attaching a battery as a power source for the electric motor, and a rear handle;
the battery attachment portion is disposed at at least one of the motor housing and the rear handle;
the circular cutting blade is configured to cut the workpiece as the cutting device moves in a cut proceeding direction while the base contacts the workpiece;
a surface of the circular cutting blade is parallel to the cut proceeding direction; and
a rotation center of the electric motor is parallel to the surface of the cut proceeding direction.

12. The cutting device according to claim 11, wherein the battery attachment portion is disposed at the motor housing.

13. The cutting device according to claim 11, wherein the battery attachment portion is disposed at the rear handle.

14. The cutting device according to claim 11, wherein the battery attachment portion is configured such that a plurality of batteries are attached to the battery attachment portion as the plurality of batteries are slid along the battery attachment portion in directions parallel to each other.

15. The cutting device according to claim 11, wherein:
the rear handle extends from the motor housing in a rear direction with respect to the cut proceeding direction; and
the blade case is disposed on a lateral side of the motor housing.

16. The cutting device according to claim 15, wherein:
the tool main body further comprises a front handle disposed on a front side of the motor housing with respect to the cut proceeding direction and on a lateral side of the blade case; and
the battery attachment portion is configured such that the battery is attached to the battery attachment portion at a position on a rear side of the front handle.

17. A cutting device comprising:
a base configured to contact with a workpiece to be cut; and
a cutting tool main body supported on an upper surface side of the base, wherein:
the cutting tool main body includes a motor housing configured to house an electric motor, a blade case configured to cover a circular cutting blade rotatably driven by the electric motor, a battery attachment portion configured to be capable of attaching a battery as a power source for the electric motor, and a rear handle extending rearward from the motor housing with respect to a cut proceeding direction;
the circular cutting blade is configured to cut the workpiece as the cutting device moves in the cut proceeding direction while the base contacts the workpiece;
a surface of the circular cutting blade is parallel to the cut proceeding direction;
a rotation center of the electric motor is parallel to the surface of the cut proceeding direction; and
the battery attachment portion is configured such that the battery is attached to the battery attachment portion as the battery is slid along the battery attachment portion in a sliding direction within a plane parallel to the surface of the cutting blade.

18. The cutting device according to claim 17, wherein the battery attachment portion is configured such that a plurality of batteries are attached to the battery attachment portion as the plurality of batteries are slid along the battery attachment portion in sliding directions that are parallel to each other.

19. The cutting device according to claim 17, wherein the battery attachment portion is disposed at at least one of the motor housing and the rear handle.

20. The cutting device according to claim 17, wherein the sliding direction of the battery is inclined relative to the cut proceeding direction.
